(19) United States
(12) Patent Application Publication
(10) Pub. No.: US 2025/0170599 A1
(43) Pub. Date: May 29, 2025

(54) PROCESS FOR PRODUCING A COATED OBJECT COMPRISING COATING LAYERS HAVING ADJUSTABLE PROPERTIES

(71) Applicant: BASF COATINGS GMBH, Muenster (DE)

(72) Inventors: Christian BECKHAUS, Muenster (DE); Pieter MOONEN, Muenster (DE); Matthijs GROENEWOLT, Muenster (DE)

(21) Appl. No.: 18/839,957

(22) PCT Filed: Mar. 16, 2023
(86) PCT No.: PCT/EP2023/056715

§ 371 Date: Aug. 20, 2024

(30) Foreign Application Priority Data
Mar. 23, 2022 (EP) 22163711.9

(51) Int. Cl. B05B 7/04; B62D 65/00

(52) U.S. Cl. CPC B05B 7/04; B62D 65/00

(57) ABSTRACT

Described herein is a process for producing a coated object including a plurality of target areas where at least part of the plurality of target areas is coated with coating layers having adjustable properties. Also described herein are a method of using the process for preparing a coated object including target areas requiring coating layers having different properties. and a system for applying—utilizing an application device—at least two coating compositions resulting in coating layers having adjustable properties to an object including a plurality of target areas, where at least part of the plurality of target areas have a different set of properties.

The present invention relates to a process for producing a coated object comprising a plurality of target areas wherein at least part of the plurality of target areas is coated with coating layers having adjustable properties. The coating layers are produced by applying coating compositions to target area(s) such that the properties of the resulting coating layers match the set of properties of the respective target area(s), i.e. the coating layers are produced such that the same coating layer is not present on target areas having a different set of properties. The inventive process allows to match the properties of a coating layer, such as the flexibility, hardness, scratch resistance, light resistance to the set of properties required for the respective target area(s). This results in a coated object having higher overall mechanical and/or chemical properties because the properties of the coating layers can be matched to set of properties required for the respective target area(s). Furthermore, the present invention relates to the use of the inventive process for preparing a coated object comprising target areas requiring coating layers having different properties. Finally, the present invention relates to a system for applying—utilizing an application device—at least two coating compositions resulting in coating layers having adjustable properties to an object comprising a plurality of target areas, wherein at least part of the plurality of target areas having a different set of properties.

### PRIOR ART

In the painting of high-quality goods, for example automobiles, the paint is usually applied in multiple layers. In multilayer paint systems of this kind for automobile chassis, a primer is first applied, which is intended to improve the adhesion between the substrate and the subsequent layers, and also serves to protect the substrate from corrosion if it is prone to corrosion. In addition, the primer ensures an improvement in the surface characteristics, by covering over any roughness and structure present in the substrate. Especially in the case of metal substrates, a primer-surfacer is often applied to the primer, the task of which is to further improve the surface characteristics and to improve the resistance to stonechipping. Typically, one or more coloring and/or effect layers are applied to the primer-surfacer, which are referred to as the basecoat.

Finally, a clearcoat is generally applied to the basecoat, which ensures the desired shiny appearance and protects the paint system from environmental effects.

Combinations of a basecoat with a clearcoat are also referred to as composite color-plus-clear coatings.

Color-plus-clear systems are often selected when an exterior coating must possess an optimum visual appearance as well as superior durability and weatherability. As a result, the automotive industry has made extensive use of color-plus-clear composite coatings, especially for automotive body panels. Clearcoats used in color-plus-clear systems are normally applied at film builds significantly higher than the film builds at which the colored basecoat is applied. Such higher clearcoat film builds are an aspect of the system that contributes toward the desired appearance and/or durability of the overall color-plus-clear system. For example, automotive original equipment manufacturing (OEM) facilities typically apply clearcoat compositions at wet film builds of from 20.3 to 152.4 μm (0.8 to 6.0 mils) to provide cured clearcoat film builds of from 12.7 to 88.9 μm (0.5 to 3.5 mils). In contrast, the colored basecoat compositions are usually applied at wet film builds of from 5.1 to 101.6 μm (0.2 to 4.0 mils) to provide cured basecoat film builds of from 2.5 to 50.8 μm (0.1 to 2.0 mils).

Minimum performance requirements for clearcoat coating compositions intended for use on automotive body panels include high levels of adhesion, scratch and mar resistance, chip resistance, humidity resistance, and weatherability as measured by QUV and the like. The clearcoat composition must also be capable of providing a visual appearance characterized by a high degree of gloss, distinctness of image (DOI), and smoothness. Finally, such coatings must also be easy to apply in a manufacturing environment and be resistant to application defects.

However, a clearcoat layer having a higher stone chipping resistance has traditionally shown reduced chemical resistance due to its higher flexibility required for the higher stone chipping resistance. Identical conflicting requirements arise with regard to scratch resistance or light resistance, because clearcoat layers having a higher scratch resistance and/or light resistance are normally more expensive in production than clearcoat layers having lower scratch resistance and/or light resistance. In terms of efficiency, it is therefore desirable to only produce the clearcoat layer having a high scratch resistance and/or a high light resistance onto said target areas requiring said high scratch resistance and/or light resistance while the further target areas are covered with a less expensive clearcoat layer having a lower scratch resistance and/or light resistance.

Clearly, high stone chipping resistance and high chemical resistance are conflicting requirements. The same is true for achieving good scratch resistance and/or a good light resistance without significantly increasing the overall costs for the coating. One approach to obtain sufficient overall properties is to carefully control the properties of the coating layer resulting from applying a coating material to the object to ensure that the coating layer shows a proper balance between stone chipping resistance and chemical resistance or a proper balance between scratch resistance and/or light resistance and overall costs for coating the object. This approach is currently used in the automotive manufacturing industry (also called OEM hereinafter), where only one clearcoat quality having a good balance between stone chipping resistance and chemical resistance or between scratch resistance and/or light resistance and overall costs for the coating. While the use of said clearcoat quality results in sufficient mechanical and chemical properties, the stone chipping resistance cannot be increased without simultaneously decreasing the chemical resistance or vice versa.

The same applies for increasing the scratch resistance and/or light resistance without simultaneously increasing the overall costs for the coating or vice versa.

It would be advantageous to apply different coating materials resulting in coating layers having properties which are customized to the properties of the areas of the object to be coated, as then the properties of the coating layers could be optimized independent of each other to achieve a higher quality in terms of mechanical and/or chemical properties of the resulting coated object. The coating layers having customizable properties should be easy to produce from a limited number of coating compositions and the coating compositions should be suitable for use in combination with conventional application equipment. Moreover, the adjusted properties of the coating layers should result in a more efficient usage of associated coating compositions in terms of material consumption because their properties are tuned to the properties of the respective target area(s), thus rendering production of higher film builds of an untuned coating layer to achieve the same result superfluous.

Object Therefore, an object of the present invention is to provide a process which allows to match the properties of the coating layer to the set of properties, such as stone chipping resistance, chemical resistance, scratch resistance, light resistance, of the respective target area of the object the coating layer is present on to improve the overall mechanical and chemical properties of the coated object. Production of coating layers having properties tuned to the properties of the respective target area of the object should result in lower consumption of the coating compositions used for their production, thus rendering the process more efficient and reducing generation of volatile organics during curing of the applied coating materials. Finally, the process should be performed with commonly used application equipment.

### Technical Solution

This problem is solved by the subject matter claimed in the claims and also by the preferred embodiments of that subject matter as described hereinafter.

A first subject of the present invention is therefore a process for preparing an object comprising a plurality of target areas, at least part of the plurality of target areas having a different set of properties, and being coated with at least two coating layers having adjustable properties, said process comprising
(a) identifying at least two target areas and the set of properties associated with each identified target area, wherein at least two target areas have a different set of properties,
(b) providing at least two different coating compositions (Cᵢ)_{i=1, . . . , n}, wherein each coating composition (C₁, . . . Cₙ) results in a coating layer (CL₁, . . . CLₙ) having properties matching a different set of properties identified in step (a), and (c) applying each coating composition (C₁, . . . , Cₙ) provided in step (b) onto the target area(s) associated with the matching set of properties.

The above-specified process is hereinafter also referred to as process of the invention and accordingly is a subject of the present invention. Preferred embodiments of the process of the invention are apparent from the description hereinafter and also from the dependent claims.

The inventive process allows to match the properties of coating layers to the set of properties of the respective target area(s) of the object. For example, coating layers having a high flexibility are produced on target areas of the object requiring high stone chipping resistance, such as the front of an automotive, while coating layers having a low flexibility, but a high chemical resistance are produced on target areas requiring low stone chipping resistance but high chemical resistance, such as the roof of an automotive. In another example, coating layers having a high scratch resistance, or a high light resistance are only produced on target areas requiring high scratch resistance, such as the sides of the automotive, or target areas requiring a high light resistance, such as the roof of the automotive. This allows to reduce the overall costs associated with the inventive process, because it avoids producing coating layers having optimized properties and being associated with higher costs on target areas not requiring said optimized properties. Production of coating layers having properties matching the set of properties of the target area(s) allows to reduce the overall film thickness as compared to coating layers having balanced properties. This allows to reduce the emissions produced during drying of the coating compositions and results in a more efficient coating process. Moreover, matching of the properties of the coating layer to the different sets of properties of the target areas of the object results in a higher quality in terms of mechanical and/or chemical properties of the resulting coated object.

A further subject of the present invention is the use of the inventive process for preparing a coated object comprising target areas requiring coating layers having different properties.

A further subject of the present invention is a system for applying—utilizing an application device—at least two coating compositions resulting in coating layers having adjustable properties to an object comprising a plurality of target areas, at least part of the plurality of target areas having a different set of properties, the system comprising:
an application device comprising a nozzle;
a storage device for storing application instructions and optionally mixing ratio instructions;
one or more data processors configured to execute the application instructions and optionally the mixing ratio instructions to control the application device; and
at least two reservoirs in fluid communication with the application device and configured to contain at least two components (Aᵢ)_{i=1, . . . , n} and optionally at least one hardener component B, each component Aᵢ or each mixture of Aᵢ and B resulting in a coating layer CLᵢ having properties matching a set of properties of target area(s), or configured to contain at least two coating compositions (Cᵢ)_{i=1, . . . , n} resulting in coating layer (CLᵢ)_{i=1, . . . , n}, each coating layer CLᵢ having properties matching a set of properties of target area(s),
wherein the application device is configured to
   receive the components (Aᵢ)_{i=1, . . . , n} and optionally the hardener component B from the reservoir and to mix the components (Aᵢ)_{i=1, . . . , n}, optionally with the hardener component B based on the mixing ratio instructions within the nozzle, and
   to expel the resulting coating compositions (Cᵢ)_{i=1, . . . , n} based on the application instruction through the nozzle to target area(s) having a matching set of properties to form at least two coating layers; or
wherein the applicator is configured to
   receive the at least two coating compositions (Cᵢ)_{i=1, . . . , n} from the reservoir, and
   to expel the coating compositions (Cᵢ)_{i=1, . . . , n} based on the application instruction through the nozzle to at least two target areas having a matching set of properties to form at least two coating layers.

A further subject of the present invention is a system for applying—utilizing an application device—at least two clearcoat coating compositions resulting in clearcoat coating layers having adjustable properties to an object comprising a plurality of target areas, at least part of the plurality of target areas having a different set of properties, wherein each applied coating composition results in a clearcoat coating layer having properties matching a set of properties of at least two target areas, the system comprising:
an application device comprising a nozzle;
a storage device for storing application instructions and associated mixing ratio instructions;
one or more data processors configured to execute the application instructions and the mixing ratio instructions to control the application device; and
at least three reservoirs in fluid communication with the application device and configured to contain at least two components (Aᵢ)_{i=1, . . . , n} and at least one hardener component B, wherein the application device is configured to
   receive the components (Aᵢ)_{i=1, . . . , n} and the hardener component B from the reservoir and to mix one or more components (Aᵢ)_{i=1, . . . , n}, with the hardener component B based on the mixing ratio instructions within the nozzle to prepare clearcoat coating compositions (C₁, . . . , Cₙ), and
   to expel the resulting coating compositions (Cᵢ)_{i=1, . . . , n} based on the application instructions associated with the mixing instructions used to prepare the respective clearcoat composition Cᵢ through the nozzle to target area(s) having a set of properties matching the properties of the respective clearcoat layer produced from the respective clearcoat composition Cᵢ to form at least two clearcoat coating layers.

A further subject matter of the present invention is a system for coating an object comprising a plurality of target areas, at least part of the plurality of target areas having a different set of properties, with at least two clearcoat coating layers, each clearcoat coating layer having properties matching a different set of properties of the target areas, said system comprising:
a) a computing unit configured to determine control data for controlling an application device by:
   obtaining data associated with the object to be coated and determining target area location data for at least part of the plurality of target areas and target area property data for each of said target areas based on the obtained data associated with the object,
   obtaining data associated with the components used to prepare the clearcoat coating compositions to be applied and determining mixing ratio data based on the determined target area property data,
   generating the control data including the determined target area location data and associated mixing ratio data and providing the generated control data to one or more data processors configured to control the application device,
b) one or more data processors configured to execute the provided control data to control the application device,
c) the application device comprising a nozzle and at least three reservoirs in fluid communication with the application device and configured to contain at least two components (Aᵢ)_{i=1, . . . , n} and at least one hardener component B, the application device being configured to:
   receive the one or more components and the at least one hardener component B from the reservoirs and mix the received component(s) and hardener component(s) B based on the mixing ratio data within the nozzle to prepare clearcoat coating compositions (C₁, . . . , Cₙ), and
   expel each prepared clearcoat coating composition (Cᵢ)_{i=1, . . . , n} through the nozzle to the target area(s) associated with the target area location data linked to the mixing ratio data used to prepare the respective clearcoat composition Cᵢ to form a clearcoat coating layer having properties matching the property of the target area(s).

### DETAILED DESCRIPTION

### Definitions

First of all, a number of terms used in the context of the present invention will be explained.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

In this description of the invention, for convenience, “polymer” and “resin” are used interchangeably to encompass resins, oligomers, and polymers.

The term “poly(meth)acrylate” stands both for polyacrylates and for polymethacrylates. Poly(meth)acrylates may therefore be constructed of acrylates and/or methacrylates and may contain further ethylenically unsaturated monomers such as, for example, styrene or acrylic acid. The term “(meth)acryloyl” respectively, in the sense of the present invention embraces methacryloyl compounds, acryloyl compounds and mixtures thereof.

The term “plurality of target areas” refers to at least two target areas being present on the object to be coated. A target area is a defined area, i.e. an area having defined dimensions, on the object. The term “at least part of the plurality of target areas having a different set of properties” means, in the sense of the present invention, that at least two target areas of the plurality of target areas have a different set of properties. Thus, either all target areas present on the object have a different set of properties, i.e. the properties of each target area differ from the properties of each further target area, or some target areas have the same set of properties while other target area(s) have a different set of properties. The term “set of properties” refers to either a single property or a number of properties associated with said target areas. The properties can be selected from the orientation of the target area relative to other target areas, the position of the target area on the object or a combination thereof. The term “different set of properties” means within the sense of the present invention that at least one property of the number of properties associated with the respective target area differs from the properties contained in the set of properties associated with another target area. Thus, the term “different set of properties does not necessarily mean that all properties included in the set of properties differ from properties contained in another set of properties.

The term “object being coated with at least two coating layers having adjustable properties” refers to an object which is coated with at least two coating layers and wherein the properties of the coating layers have been adjusted to match the set of properties of the target areas each coating layer is present on. This can be achieved, for example, by using defined coating materials which, after application onto the respective target area(s) result in coating layers having properties matching the set of properties of the target area(s) the coating layer has been produced on. For example, a coating material containing a plasticizer to result in a flexible coating layer is produced on target areas, such as vertically oriented target areas, requiring coating layers having a high flexibility while a coating material containing no or lower amounts of plasticizer is applied onto target areas, such as horizontally oriented target areas, requiring coating layers having a high hardness to result in a high chemical resistance.

In another example, a coating material containing high amounts of UV filters and/or UV stabilizers to result in a coating layer having a high UV stability is produced on target areas, such as horizontally oriented target areas, requiring coating layers having a high UV stability, while a coating material containing lower amounts of UV filters and/or UV stabilizers and thus having a lower price is applied onto the remaining target areas, such as the vertically oriented target areas. In yet another example, a coating material resulting in coating layers having a high hardness and UV resistance is applied onto target areas, such as exterior target areas of a vehicle, requiring coating layers having high scratch and UV resistance, while a coating material having a lower price and resulting in coating layers having a lower scratch and UV resistance is applied onto interior target areas of the vehicle.

The term “(Cᵢ)_{i=1, . . . , n}” denotes a sequence of coating compositions C, such as, for example C₁, C₂, C₃, . . . , Cₙ with n being the last member of the sequence. The same applies to the term “(CLᵢ)_{i=1, . . . , n}”, which denotes a sequence of coating layers CL.

The term “each coating layer having properties matching a different set of properties” means within the sense of the present invention that the properties of each coating layer match exactly one set of properties of target area(s). If, for example, the object is to be coated with 2 coating layers and the object comprises target areas having two different sets of properties, the properties of the first coating layer match the first set of properties and the properties of the second coating layer match the second set of properties or vice versa.

The term “applying each coating composition onto target area(s) associated with the matching set of properties” refers to an application process in which each coating composition is applied onto target areas having a set of properties which matches the properties of the coating layer(s) produced from the respective coating composition. Thus, for example, if the coating composition C₁ results in coating layer CL₁ having properties SP₁ which match the set of properties SP₁ of target areas A₁, A₃ and A₅, said coating composition C₁ is applied in one step or in a plurality of steps to produce coating layers CL₁ on said target areas A₁, A₃ and A₅. Application of a coating composition to a defined target area or to more than one defined target area does, however, not exclude that some parts of adjacent target areas having a different set of properties are unintentionally coated with said coating composition because of occurring overspray effects. However, the same coating composition is not intentionally applied onto target areas having a different set of properties.

A “hardener component” in the context of the present invention is a material comprising at least one crosslinking component being capable of reacting with functional chemical groups being present with at least one compound contained in at least one component provided in step (a) of the inventive process, for example at least one binder. Reaction of the crosslinking component with the binder being present in at least one component provided in step (a) results in the formation of a network structure upon curing of the applied coating composition.

“Binder” in the context of the present invention and in accordance with DIN EN ISO 4618:2007-03 is the nonvolatile component of a coating composition, without pigments and fillers. Hereinafter, however, the expression is used principally in relation to particular physically and/or chemically curable polymers, examples being polyurethanes, polyesters, polyethers, polyureas, polyacrylates, polysiloxanes and/or copolymers of the stated polymers. The nonvolatile fraction may be determined according to DIN EN ISO 3251: 2018-07 at 130° C. for 60 min using a starting weight of 1.0 g.

As used herein, the term “water-based coating composition” refers to a coating composition which comprises a water fraction of at least 20 wt. %, preferably at least 25 wt. %, very preferably at least 50 wt. %, based in each case on the total weight of the coating composition. The water fraction is preferably 40 to 60 wt. %, more particularly 45 to 70 wt. %, very preferably 50 to 80 wt. %, based in each case on the total weight of the coating composition. In contrast, the term “solvent-based coating composition” refers to a coating composition with comprises a fraction of organic solvents of at least 20 wt. %, preferably at least 25 wt. %, very preferably at least 45 wt. %, based in each case on the total weight of the coating composition. The organic solvent fraction is preferably 40 to 70 wt. %, more particularly 45 to 65 wt. %, very preferably 50 to 60 wt. %, based in each case on the total weight of the coating composition.

As used herein, the term “drying” of the applied coating composition refers to the evaporation of solvents from the applied coating composition. Drying can be performed at ambient temperature or by use of elevated temperatures. However, the drying does not result in a coating film being ready for use, i.e. a cured coating film as described below, because the coating film is still soft or tacky after drying. Accordingly, “curing” of the applied coating composition or the coating film resulting from drying the applied coating composition refers to the conversion of such a composition or film into the ready-to-use state, i.e. into a state in which the object provided with the respective coating layer can be transported, stored and used as intended. More particularly, a cured coating layer is no longer soft or tacky, but has been conditioned as a solid coating layer which does not undergo any further significant change in its properties, such as hardness or adhesion to the object, even under further exposure to curing conditions. Curing can be performed at higher temperatures and/or for longer times than used for drying of the applied coating composition.

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

All temperatures elucidated in the context of the present invention should be understood as the temperature of the room in which the object or the coated object is located. It does not mean, therefore, that the object itself is required to have the temperature in question.

### Inventive Process:

The process of this invention allows to prepare a coated object comprising at least two coating layers having adjustable properties by matching the properties of the coating layers to the different sets of properties of target areas of the object such that coating layers having defined properties, like a high stone chip resistance, a high chemical resistance, a high scratch resistance and/or a high light resistance, are present on those target areas of the object that require said defined properties. For example, coating layers resulting in a high stone chipping resistance, i.e. flexible coating layers having a low chemical resistance, are present on target areas requiring high stone chipping resistance (such as the front or sides of an automotive) while coating layers having a high chemical resistance, i.e. coating layers having a high hardness and thus a low flexibility, are present on target areas requiring high chemical resistance (such as the roof of an automotive). Matching of the set of properties of the target areas to the properties of the coating layers allows to obtain improved mechanical and/or chemical properties of the resulting coated object as well as reduced material consumption during production of the respective coating layers.

According to a preferred embodiment of the process, the adjustable properties of the coating layers include the hardness, the scratch resistance, the light resistance, the appearance and/or the adhesion of the coating layers. The hardness of coating layers can, for example, be adjusted by using commonly known plasticizing agent or by using binders providing cured coating layers having a higher flexibility, such as flexible polyester resins. The scratch resistance can be improved by using silanized binders which provide additional crosslinking during hardener such that the crosslinking density and thus the overall hardness is improved or by using any of the nanosized inorganic, organic, or inorganic/organic hybrid materials known in the art. The light resistance of coating layers can be improved, for example, by adding larger amounts or specific types of UV stabilizers or UV filters to the coating material used to prepare the respective coating layer. The term “appearance” refers to the appearance of a clearcoat layer and includes gloss, haze, distinctiveness of image (DOI), orange peel, mottling, transparency or a combination thereof.

### Step (a):

Step (a) of the inventive process includes identifying at least two target areas as well as the set of properties associated with each identified target area, wherein at least two of the identified target areas have a different set of properties. In one example, the object includes at least two target areas, each target area having a different set of properties. In another example, the object comprises a plurality of target areas, wherein part of the plurality of target areas have the same set of properties, while the remaining part of the plurality of target areas have a different set or different sets of properties.

Identification of target areas and associated sets of properties may be performed according to a number of methods, some of which are illustrated in a non-limiting manner below. According to an embodiment of step (a), step (a) includes at a computing device with a display and one or more user input devices adapted to detect user input:
(a-1) displaying a user interface comprising the object on the display,
(a-2) detecting a user input being indicative of identifying at least two target areas and the set of properties associated with each target area on the object,
(a-3) determining the target areas and each set of properties associated with each identified target area based on the detected user input, and
(a-4) providing the data determined in step (a-3) to an application equipment and/or display the data determined in step (a-3) within the user interface.

The computing device comprises—apart from the display and the at least one user input device—a processor and a memory. The term “memory” may refer to physical and other computer-readable media for carrying or storing computer-executable instructions and/or data structures. Such computer-readable media can be any available media that can be accessed by a general—purpose or special-purpose computer system. Computer-readable media may include physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention. Said computer-executable instructions allow the computing device to detect a user input, to determine the target areas and each set of properties associated with each identified target area based on the detected user input and to provide the determined data to an application equipment or to the display.

The term “processor” refers to an arbitrary logic circuitry configured to perform basic operations of a computer or system, and/or, generally, to a device which is configured for performing calculations or logic operations. In particular, the processing means, or computer processor may be configured for processing basic instructions that drive the computer or system. As an example, the processing means or computer processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processing means, or computer processor may be a multicore processor. Specifically, the processing means, or computer processor may be or may comprise a Central Processing Unit (“CPU”). The processing means or computer processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processing means or processor may also refer to one or more processing devices, such as a distributed system of processing devices located across multiple computer systems (e.g., cloud computing), and is not limited to a single device unless otherwise specified. The terms “processor” and “computer processor” are used synonymously herein. The processors are configured to execute the computer-executable instructions stored on the memory.

The display may be any display device commonly known in the state of the art, such as a mobile or portable display device. The display device may also comprise the user input device, such as a touchscreen. In this case, the display detects the user input and provides the detected user input to the computing device.

In step (a-1), a user interface comprising the object is displayed on the display. The object may be any virtual 2D or 3D object, for example an automotive or a part thereof. With preference, the virtual object resembles the real object to be coated to increase the user comfort during identifying the target areas and associated sets of properties. The user interface may further comprise tool bar(s) which allow the user to mark identified target areas and to assign labels to the identified target areas indicating the associated set of properties.

In step (a-2), the computing device detects a user input being indicative of identifying at least two target areas and the set of properties associated with each target area on the object. The user input may be detected with the processor(s) of the computing device or with the processor(s) of the display. In the latter case, the detected input is provided via a communication interface to the computing device. The user input is performed using the input device, such as a touchscreen, a mouse, a keyboard, a trackpad or a combination thereof. The user input may comprise drawing boundaries around each target area or may comprise marking points on the border of each target area. The user input further includes the set of properties associated with each identified target area. This may, for example, be accomplished by adding a label associated with a respective set of properties to the respective target area or by entering the set of properties in a field associated with the respective target area.

In step (a-3), the processor(s) of the computing device determine—based on the detected user input—the target areas and each set of properties associated with each identified target area. Determination of the target areas may be made by determining the boundaries of each target area based on the user input and assigning a number to each target area. Determination of the set of properties associated with each target area may be made by determining the type of label or by determining the data entered by the user in the previous step. The identified target areas are preferably interrelated with the associated set of properties, for example by storing a unique number being indicative of the respective target area with the data on the set of properties on a data storage medium, such as the internal memory of the computing device.

In step (a-4), the data determined in step (a-3) is provided to an application equipment and/or displayed within the user interface. In the first case, the computing device is connected via the communication interface to the application equipment and the application equipment uses said data to automatically apply a coating composition to the respective target area as described later on. Displaying the determined target areas and each set of associated properties within the user interface allows the user to check whether the target areas are marked correctly and whether the correct set of properties has been assigned. The user may change the displayed data and the processor may detect the change and determine the target areas and associated set of properties based on the corrected user input. The processor may be configured to update the user interface automatically after determining the new target areas and/or new set(s) of properties based on the detected correction. The determined data may be stored on a data storage medium after interrelating said data with a unique ID to facilitate retrieval if said data is to be used again.

In an alternative embodiment of step (a), step (a) includes providing a user interface containing an object, said object comprising at least two marked target areas and an indication to the set of properties associated with the marked target areas. The user interface may be generated using data of a virtual 2D or 3D object, data on target areas present on said object and sets of properties assigned to the target areas. In one example, the user interface is generated by loading previously stored data on a virtual object, assigned target areas and associated properties and displaying said data within the user interface. The data may be generated using steps (a-1) to (a-3) previously described.

In yet another alternative embodiment, step (a) includes visually determining at least two target areas and the set of properties associated with each identified target area, wherein at least two target areas have a different set of properties. “Visually determining target areas” refers to a process of determining said areas without the use of computing device, for example by drawing target areas on an object printed on paper or by marking target areas on a real preexisting object.

### Step (b):

In step (b) of the inventive process, at least two different coating compositions (Cᵢ)_{i=1, . . . , n} are provided. Each provided coating composition (C₁, . . . , Cₙ) results—after application onto the object—in a coating layer (CL₁, . . . , CLₙ) having properties matching a different set of properties identified in step (a). Thus, each coating composition (C₁, . . . , Cₙ) provided in step (b) results in a coating layer having properties which match a set of properties identified in step (a). Moreover, each coating composition (C₁, . . . , Cₙ) is preferably not applied onto target areas having sets of properties which do not match the properties of the coating layer resulting from each applied coating composition. Thus, each coating composition (C₁, . . . , Cₙ) is preferably only applied onto target areas having the same set of properties, wherein said set of properties is matching the properties of the resulting respective coating layer. This allows to obtain coating layers having properties which match the properties of the respective target areas, thus resulting in higher overall mechanical and/or chemical properties of the coated object. Moreover, the material consumption is reduced because the optimized coating layers can be produced in a reduced film thickness as compared to coating layers not being optimized with respect to their properties.

Coating Compositions (Cᵢ)_{i=1, . . . , n} Provided in Step (a): The coating compositions (Cᵢ)_{i=1, . . . , n} provided in step (b) may be a liquid solvent—or water-based coating composition. With preference, the coating composition C₁ provided in step (a) and each further coating composition Cₓ provided upon repeating step (a) at least once is a liquid solvent-based coating composition. In particular, the coating composition C₁ provided in step (b) is a liquid solvent-based coating composition.

The coating compositions (Cᵢ)_{i=1, . . . , n} provided in step (b) can be transparent, semi-transparent or opaque. Opaque coating compositions are colored coating compositions which, when applied onto an object, have a luminous transmittance of less than 4 percent as measured at a film thickness of 15 to 18 micrometers according to ASTM D 1003-00 (procedure A) using a CIE standard illuminant D65. Suitable opaque coating compositions include basecoat compositions comprising color and/or effect pigment(s) in a concentration which is high enough to achieve the aforementioned luminous transmittance. In contrast, semi-transparent coating compositions have a luminous transmittance of at least 4 percent when applied onto an object. Semi-transparent coating compositions are therefore neither fully transparent nor opaque. In contrast to transparent coating compositions, semi-transparent coating compositions contain color and/or effect pigments and/or matting agents such that they are not fully transparent. Semi-transparent coating compositions can be colored semi-transparent coating compositions, such as tinted clearcoat compositions. Transparent coating compositions preferably include clearcoat compositions.

According to a preferred embodiment, at least one provided coating composition Cᵢ results in a coating layer CLᵢ having a high stone chip resistance and at least one further provided coating composition Cₙ₋ᵢ results in a coating layer CLₙ₋ᵢ having a high chemical resistance and/or wherein at least one provided coating composition Cᵢ results in a coating layer CLᵢ having a high scratch resistance and at least one further provided coating composition Cₙ₋ᵢ results in a coating layer CLₙ₋ᵢ having a lower scratch resistance and/or wherein at least one provided coating composition Cᵢ results in a coating layer CLᵢ having a high light resistance and at least one further provided coating composition Cₙ₋ᵢ results in a coating layer CLₙ₋ᵢ having a lower light resistance. This allows to match the properties of the resulting coating layers to the position of the target area on the substrate, resulting in higher overall mechanical and/or chemical properties of the coated object.

### Binder:

In an embodiment, each provided coating composition (C₁, . . . , Cₙ) comprises at least one binder. The at least one binder present in each provided coating composition (C₁, . . . , Cₙ) may be identical to at least one binder being present in the other provided coating composition or the at least one binder being present in each provided coating composition (C₁, . . . , Cₙ) may be different from the binder(s) present in the other provided coating composition. It may be beneficial if each coating composition comprises at least one identical binder, i.e. each provided coating composition contains at least one binder being identical to the binder(s) present in the other provided coating composition. This allows to prepare the coating compositions from components (A₁, . . . , Aₙ) as described later on without the occurrence of unwanted incompatibilities having a negative influence on the application of the resulting coating composition or the properties of the resulting coating layer CLᵢ.

Suitable binders include (i) poly(meth)acrylates, more particularly hydroxy-functional and/or carboxylate-functional and/or amine-functional poly(meth)acrylates, (ii) polyurethanes, more particularly hydroxy-functional and/or carboxylate-functional and/or amine-functional polyurethanes, (iii) polyesters, more particularly polyester polyols, (iv) polyethers, more particularly polyether polyols, (v) copolymers in the stated polymers, and (vi) mixtures thereof. With particular preference, the at least one binder is selected from hydroxy-functional poly(meth)acrylates and/or polyesters.

The hydroxy-functional (meth)acrylate(s) may contain—in polymerized form—at least one unsaturated monomer comprising at least one acid group M1, at least one unsaturated aliphatic and/or cycloaliphatic monomer M2, at least one unsaturated aromatic monomer M3 and at least one unsaturated hydroxy-group containing monomer M4. Where it is stated in the context of the present invention that the hydroxy-functional (meth)acrylate(s) comprises components M1 to M4 in polymerized form, this means that these particular components are used as starting compounds for the preparation of the hydroxy-functional (meth)acrylate(s) in question. Since the monomers M1 to M4 can be polymerized via their unsaturated moieties, the hydroxy-functional (meth)acrylate(s) preferably comprises the unsaturated moieties, previously present in monomers M1 to M4, in the form of C—C single bonds, in other words in their correspondingly reacted form.

Suitable unsaturated monomers comprising at least one acid group M1 include (meth)acrylic acid.

The at least one unsaturated aliphatic monomer M2 can be selected from alkyl (meth)acrylates, more preferably from C₁-C₂₂ alkyl (meth)acrylates, even more preferably from C₁-C₁₄ alkyl (meth)acrylates such as C₃ alkyl (meth)acrylates, C₄ alkyl (meth)acrylates, C₅ alkyl (meth)acrylates, C₆ alkyl (meth)acrylates, C₇ alkyl (meth)acrylates and C₁₃ alkyl (meth)acrylates, very preferably from butyl (meth)acrylate and/or (meth)acrylic ester 13.0.

Suitable unsaturated cycloaliphatic monomers M2 include cycloalkyl (meth)acrylates, such as cyclo-C₅-C₇-alkyl (meth)acrylates, in particular cyclohexyl (meth)acrylate. The at least one unsaturated aromatic monomer M3 can be selected from styrene. Suitable unsaturated hydroxy-group containing monomers M4 include hydroxyl group-containing (meth)acrylates, more preferably hydroxy C₁-C₁₂ alkyl group-containing (meth)acrylates, such as 2-hydroxyethyl (meth)acrylate, 2-hydroxyisopropyl (meth)acrylate, 3-hydroxypropyl (meth)acrylate, hydroxyisobutyl (meth)acrylate and 4-hydroxybutyl (meth)acrylate, in particular 2-hydroxyethyl (meth)acrylate and 3-hydroxypropyl (meth)acrylate.

The hydroxy-functional (meth)acrylates can be prepared in organic solvents by polymerizing the aforementioned unsaturated monomers M1 to M4 in the presence of free radical initiators. The free radical initiators can be selected from t-amylperoxy compounds such as 1,1-di(t-amylperoxy)cyclohexane, t-amylperoxy esters such as t-amylperoxy, ethyl-3,3-di(t-amylper-oxy)butyrate and t-amylperoxyacetate, other peroxides such as di-t-butylperoxide, dicumylperoxide, cumenehydroperoxide, and t-butylperbenzoate and azo compounds such as 2,2′-azobis(2-methylbuty-ronitrile). The amount of free radical initiator that is used will vary in amounts from about 0.5 to 10 wt.-%, preferably 1 to 4 wt.-%, based on total weight of monomers M1 to M4.

In some embodiments, the at least one binder is a polyester. Suitable polyesters can be prepared by reacting poly-functional acid or anhydride compounds or a mixture of mono-functional and poly-functional acid or anhydride compounds with polyfunctional alcohols. Typical acid compounds include alkyl, alkylene, aralkylene, and aromatic monocarboxylic acids, dicarboxylic acids and anhydrides; however, acids or anhydrides with higher functionality may also be used. If tri-functional compounds or compounds of higher functionality are used, these may be used in mixture with mono-functional carboxylic acids or anhydrides of monocarboxylic acids, such as versatic acid, fatty acids, or neodecanoic acid. Illustrative examples of acid or anhydride functional compounds suitable for forming the polyester groups or anhydrides of such compounds include phthalic acid, phthalic anhydride, isophthalic acid, terephthalic acid, hexahydrophthalic acid, tetrachlorophthalic anhydride, hexahydrophthalic anhydride, pyromellitic anhydride, succinic acid, azeleic acid, adipic acid, 1,4-cyclohexanedicarboxylic acid, citric acid, and trimellitic anhydride.

The polyol component used to make the polyester has a hydroxyl functionality of at least two. The polyol component may contain mono-, di-, and tri-functional alcohols, as well as alcohols of higher functionality. Diols are a typical polyol component. Alcohols with higher functionality may be used where some branching of the polyester is desired, and mixtures of diols and triols can be used as the polyol component. However, in some cases, highly branched polyesters are not desirable due to effects on the coating, such as decreased flow, and undesirable effects on the cured film, such as diminished chip resistance and smoothness. Examples of useful polyols include, but are not limited to, ethylene glycol, diethylene glycol, triethylene glycol, propylene glycol, dipropylene glycol, butylene glycol, glycerine, trimethylolpropane, trimethylolethane, pentaerythritol, neopentyl glycol, 2,2,4-trimethyl-1,3-pentanediol, 1,6-hexanediol, 1,4-cyclohexane dimethanol, hydrogenated bisphenol A, and ethoxylated bisphenols. Methods of making polyesters are well-known. Polyesters are typically formed by heating together the polyol and poly-functional acid components, with or without catalysis, while removing the by-product of water in order to drive the reaction to completion. A small amount of a solvent, such as toluene, may be added in order to remove the water azeotropically.

The at least one binder is preferably present in each provided coating composition (C₁, . . . , Cₙ) in a total amount of 10 to 70 wt.-%, preferably of 20 to 65 wt.-%, more preferably 30 to 60 wt.-%, very preferably of 40 to 50 wt.-%, based in each case on the total weight of the provided coating composition Cᵢ. If more than one binder is present, for example a mixture of hydroxy-functional poly(meth)acrylates and polyesters, the aforementioned amounts refer to the total amount of binders present in the respective provided coating composition and thus refer to the sum of the amounts of hydroxy-functional poly(meth)acrylates and polyester(s).

### Crosslinking Agent:

Each provided coating composition (C₁, . . . , Cₙ) can contain at least one crosslinking agent. The presence of at least one crosslinking agent is generally optional and is only necessary if said coating compositions contain binder(s) having functional groups which are not self-reactive. In case the coating compositions are formulated as 2K coating compositions, they are prepared by mixing a base component (usually comprising the resins, additives and optionally crosslinking agents not being reactive with the binder component at storage temperature) and at least one hardener component containing crosslinking agents prior to application. In one example, the at least one crosslinking agent present in one provided coating composition Cᵢ is identical to at least one crosslinking agent being present in the other provided coating compositions. This may be preferred to avoid incompatibilities in case the coating compositions are prepared by mixing at least two components (Aᵢ)_{i=1, . . . , n}, as described later on. In another example, each provided coating composition (C₁, . . . , Cₙ) comprises at least one crosslinking agent being different from the crosslinking agent(s) present in the other provided coating compositions.

The at least one crosslinking agent is preferably capable of reacting with functional groups of at least one compound being present in the coating composition Cᵢ. With preference, the at least one crosslinking agent is capable of reacting with functional groups of the at least one binder.

In the case where the functional group of the binder is active hydrogen, particularly OH, the curing agent can be an aminoplast or polyisocyanate with the polyisocyanate being preferred. Suitable polyisocyanates include organic polyisocyanates containing aliphatically, cyclo-aliphatically, araliphatically and/or aromatically bonded free isocyanate groups. Preference is given to using polyisocyanates having from 2 to 5 isocyanate groups per molecule and having viscosities of from 100 to 10,000 mPa*s, preferably from 100 to 5,000 mPa*s and in particular from 100 to 2,000 mPa*s (at 23° C.). Where appropriate, small amounts of organic solvent, preferably from 1 to 25 wt.-% based on straight polyisocyanate, may be added to the polyisocyanates in order to improve the ease of incorporation of the polyisocyanate and, where appropriate, to lower the viscosity of the polyisocyanate to a level within the aforementioned ranges. Examples of suitable solvent additives to the polyisocyanates include ethoxyethyl propionate, amyl methyl ketone, and butyl acetate. Moreover, the polyisocyanates may have been given a conventional hydrophilic or hydrophobic modification. Further examples of suitable polyisocyanates are polyisocyanates containing isocyanurate, biuret, allophanate, iminooxadiazinedione, urethane, urea and/or uretdione groups. Polyisocyanates containing urethane groups, for example, are obtained by reacting some of the isocyanate groups with polyols, such as trimethylolpropane and glycerol, for example. Preference is given to using aliphatic or cycloaliphatic polyisocyanates, especially hexamethylene diisocyanate, dimerized and trimerized hexamethylene diisocyanate, isophorone diisocyanate, 2-isocyanatopropylcyclohexyl isocyanate, dicyclohexylmethane 2,4′-diisocyanate, dicyclohexylmethane 4,4′-diisocyanate or 1,3-bis(isocyanatomethyl)cyclohexane, diisocyanates derived from dimer fatty acids, as sold under the commercial designation DDI 1410 by Henkel, 1,8-diisocyanato-4-isocyanatomethyloctane, 1,7-diisocyanato-4-isocyanatomethylheptane or 1-isocyanato-2-(3-isocyanatopropyl)cyclohexane or mixtures of these polyisocyanates. When the functional group is amine, the curing agent can be polyisocyanate or polyepoxide or polyanhydride; when the functional group is carboxylic acid, the curing agent can be polyepoxide or polyanhydride; when the functional group is epoxy, the curing agent can be polyacid or polyamine.

Suitable crosslinking agent comprises aminoplast resins and/or polyisocyanates, preferably aminoplast resins and aliphatic or cycloaliphatic polyisocyanates, very preferably aminoplast resins and hexamethylene diisocyanate and/or dimerized and/or trimerized hexamethylene diisocyanate.

### Sagging Control Agent (SCA):

At least one of the coating compositions Cᵢ provided in step (b) may further contain at least one sagging control agent (SCA) to adjust the thixotropic rheological behavior of said coating composition. SCA's affect the sag-leveling properties of a coating composition as the SCA particles tend to form a loose, percolating network at low shear stress through controlled flocculation. At high shear stress (e.g. during spraying of the coating composition) the SCA-network is destroyed and the effect of SCA-addition on the high-shear viscosity is nearly zero as SCA's are typically used in low concentrations. After application, the wet coating composition experiences a low (gravitational) shear stress. Under these low-shear conditions the SCA-network builds up resulting in an increase of the viscosity. This shear-thinning behavior of SCA-modified coating compositions is beneficial as it increases the sag resistance of the paint. As the rate of formation of the SCA-network is relatively slow, SCA-modified coating compositions are often thixotropic. Thus, provided coating composition(s) containing higher amounts of SCA have a better sag resistance than provided coating composition(s) containing lower amounts of SCA or being free of SCA (i.e. containing SCA in a total amount of less than 1 wt.-%, preferably of 0 wt.-%, based on the total weight of the coating composition). However, provided coating composition(s) containing lower amounts of SCA or being free of SCA have better leveling properties. Thus, the addition of SCA can be used to adjust the sag resistance and/or leveling properties of each provided coating composition such that these properties match the orientation of the target area. For example, coating compositions applied on horizontally oriented target areas comprise low amounts or no amounts of SCA to improve the leveling properties while coating compositions applied on vertically oriented target areas comprise higher amounts of SCA to improve the sag resistance and avoid sagging of the applied coating composition. “Vertically orientated” as used herein refers to surfaces which are substantially parallel to the direction of gravity, i.e., at an angle of 90°±45° relative to the surface of the earth, more preferably at an angle of 90°±30° relative to the surface of the earth. “Horizontally orientated” refers to surfaces which are substantially perpendicular to the direction of gravity, i.e., at an angle of 180°±45° relative to the surface of the earth, more preferably at an angle of 180°±30° relative to the surface of the earth.

The SCA's are normally anisotropic, colloidal particles that are formed by crystallization of urea molecules. The urea molecules can be obtained by reacting an isocyanate compound with a primary or secondary amine, optionally in the presence of a resin, such as a (meth)acrylate resin. The isocyanate compound be an isocyanate functional polymer, such as an isocyanate functional (meth)acrylic polymer, or can be a commonly known polyisocyanate. The reaction between the isocyanate compound and the primary or secondary amine may generally be carried out in any arbitrarily chosen way by combining the reaction components, optionally in the presence of the resin. The reaction may be carried out at a temperature in the range of 20° to 120° C., more particularly in the range of 25° to 95° C. In general, the primary or secondary amine is added directly to the isocyanate compound at the desired reaction temperature optionally in the presence of catalyst such as a tin compound. The reaction proceeds until the isocyanate has been completely consumed. In case the reaction is performed in the presence of a resin, the isocyanate compound and the primary or secondary amine are added to the resin, either together or sequentially.

It is preferred within the present invention if the sagging control agent (SCA) is selected from polymeric sagging control agents. The term “polymeric sagging control agents” refers to SCA's which are either obtained by reacting an isocyanate functional polymer with a primary or secondary amine or which are obtained by reacting a polyisocyanate with a primary or secondary amine in the presence of at least one resin. Thus, SCA's prepared by reacting polyisocyanates with amines are not encompassed by the term “polymeric sagging control agent”.

The polymeric sagging control agent (SCA) may be obtained by reacting a primary or secondary amine with an isocyanate compound in the presence of a hydroxy-functional poly(meth)acrylate. Suitable polyisocyanates that can be used for the formation of the SCA's include blocked or un-blocked aliphatic, cycloaliphatic, heterocyclic, aromatic di-, tri-, polyisocyanates or a combination thereof. Examples of suitable polyisocyanates can include 1,6-hexamethylene diisocyanate, 2,2,4-trimethylhexane-1,6-diisocyanate, 2,4,4-trimethylhexane-1,6-diisocyanate, cyclohexyl-1,4-diisocyanate, isophorone diisocyanate, the adduct of 1 molecule of 1,4-butanediol and 2 molecules of isophorone diisocyanate, the adduct of 1 molecule of 1,4-butanediol and 2 molecules of hexamethylene diisocyanate, dicyclohexylmethane-4,4′-diisocyanate, xylene diisocyanate, 1,3,5-trimethyl-2,4-bis(isocyanatomethyl)benzene, toluene diisocyanate, diphenylmethane-4,4′-diisocyanate, adducts of hexamethylene diisocyanate, adducts of isophorone diisocyanate, and adducts of toluene diisocyanate. Isocyanurate-trimers of diisocyanates can also be suitable. In some embodiments, aliphatic polyisocyanates, such as hexamethylene diisocyanate, are used.

Examples of primary amines would include benzylamine, ethylamine, n-propylamine, see propylamine, n-butylamine, sec. butylamine, tert. butylamine, n-pentylamine, alpha-methylbutylamine, alpha-ethylpropylamine, beta-ethylbutamine, hexylamine, octylamine, decylamine, stearylamine, cyclohexylamine, aniline and hexamethylene diamine. Examples of suitable secondary amines would include dibutylamine, diethylamine, diisopropylamine, diethanolamine, and diisopropanolamine. These amines would generally contain not more than 30 carbon atoms and preferably 1 to 18 carbon atoms. Amines containing one or more primary or secondary amino groups and one or more ether and/or hydroxyl groups are also applicable. For example, ethanolamine, 6-aminohexanol, p-methoxybenzylamine, methoxypropylamine, 3,4-dimethoxyphenyl-ethylamine, 2,5-dimethoxyaniline, furfurylamine, tetrahydrofurfurylamine may be used. Mixture of the amines referred to above may also be used. In some embodiments, aromatic primary amines, such as benzylamine, are used.

Suitable hydroxy-functional poly(meth)acrylates contain—in polymerized form—at least one unsaturated monomer comprising at least one acid group M1, at least one unsaturated aliphatic monomer M2, at least one unsaturated aromatic monomer M3 and at least one unsaturated hydroxy-group containing monomer M4.

Suitable unsaturated monomers comprising at least one acid group M1 include (meth)acrylic acid.

The at least one unsaturated aliphatic monomer M2 can be selected from alkyl (meth)acrylates, more preferably from C₁-C₂₂ alkyl (meth)acrylates, even more preferably from C₁-C₁₄ alkyl (meth)acrylates such as C₃ alkyl (meth)acrylates, C₄ alkyl (meth)acrylates, C₅ alkyl (meth)acrylates, C₆ alkyl (meth)acrylates, C₇ alkyl (meth)acrylates and C₁₃ alkyl (meth)acrylates.

The at least one unsaturated aromatic monomer M3 can be selected from styrene. Suitable unsaturated hydroxy-group containing monomers M4 include hydroxyl group-containing (meth)acrylates, such as C₁-C₁₂ alkyl group-containing (meth)acrylates selected from 2-hydroxyethyl (meth)acrylate, 2-hydroxyisopropyl (meth)acrylate, 3-hydroxypropyl (meth)acrylate, hydroxyisobutyl (meth)acrylate and 4-hydroxybutyl (meth)acrylate.

With particular preference, the hydroxy-functional poly(meth)acrylates contain—in polymerized form—(meth)acrylic acid, butyl (meth)acrylate and/or (meth)acrylic ester 13.0, styrene and 2-hydroxyethyl (meth)acrylate.

Suitable weight ratios of monomers M1:M2:M3:M4 include 1:50:50:30 to 1:30:20:10.

The hydroxy-functional poly(meth)acrylate can be prepared as previously described in relation to the hydroxy-functional poly(meth)acrylate binder by radical free polymerization of monomers M1 to M4.

The polymeric sagging control agent (SCA) may have an average molecular weight Mw of 3,000 to 50,000 g/mol, preferably of 4,000 to 30,000 g/mol, very preferably of 5,000 to 15,000 g/mol, as determined with GPC using polystyrene as internal standard. The viscosity of the sagging control agent may range from 500 to 4,000 mPa*s, preferably from 700 to 3,000 mPa*s, very preferably from 1,000 to 2,500 mPa*s (25° C., 10/s, Z3) (DIN ISO 2884-1:2006-09).

The hydroxy-functional poly(meth)acrylate used to prepare the polymeric sagging control agent is preferably also present in provided coating composition(s) comprising no polymeric sagging control agent or comprising lower amounts of polymeric sagging agent as compared to provided coating composition(s) comprising higher amounts of polymeric sagging agent. This allows to prepare the provided coating compositions from components (A₁, . . . ,An) as described later on without the occurrence incompatibilities, which may result in clogging of the application equipment during application of the coating compositions or a reduced optical quality of the resulting coating layer.

With preference, the sagging control agent (SCA), in particular the polymeric sagging control agent, is present in a total amount of 0.1 to 40 wt.-%, preferably of 2 to 30 wt.-%, more preferably of 3 to 20 wt.-%, very preferably of 4 to 15 wt.-%, based in each case on the total weight of the respective provided coating composition Cᵢ. Depending on the amount of SCA in each provided coating composition Cᵢ, each coating composition C, either has good leveling properties (low amounts of SCA or no SCA present) or a good sag resistance (high amounts of SCA present), as previously described.

Further Additives Apart from SCA:

Apart from the SCA, at least one provided coating composition Cᵢ may further comprise at least one additive being different from the sagging control agent (SCA).

In one example, all provided coating compositions (C₁, . . . , Cₙ) further comprise the at least one additive, in particular similar additive(s). This allows to prepare the provided coating compositions from components (A₁, . . . , Aₙ) as described later on without the occurrence incompatibilities during the preparation of the provided coating compositions.

In another example, only part of the provided coating compositions comprise the further additive(s) while the other part of the provided coating compositions does not contain said additives (i.e. contains 0 wt.-%, based on the total weight of the respective coating composition, of further additives).

Suitable additives being different from the sagging control additive include crosslinking agents, light stabilizers, leveling agents, UV absorbers, pigments, free-radical scavengers, slip additives, polymerization inhibitors, defoamers, wetting agents, adhesion promoters, flow control agents, film-forming assistants such as cellulose derivatives, fillers, rheology control additives, flame retardants and/or water scavengers, in particular crosslinking agents, light stabilizers and leveling agents.

Suitable leveling agents include silicon-containing leveling agents, such as silicone-containing leveling agents having the following structural formula:

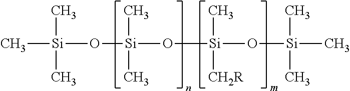

in which
R stands for hydrogen, an alkyl residue, an alkylaryl residue, a glycol residue, a hydroxy group, a hydroxyalkyl residue, an amino group or a aminoalkyl residue, and
   n and m are positive integers, respectively.

Representative silicone-containing leveling agents are dimethyl polysiloxane (R=H in the above formula) and modified silicone leveling agents in which R in the above formula is alkyl such as methyl, ethyl, propyl and the like, alkylaryl such as methylaryl, ethylaryl, and the like, glycol residue, hydroxy, hydroxyalkyl such as hydroxymethyl, hydroxyethyl, and amino.

In a preferred embodiment, each provided coating composition (C₁, . . . , Cₙ) only differs in the amount and/or type of ingredient(s) necessary to achieve properties of the respective resulting coating layer (C₁, . . . , Cₙ) which are matching a set of properties identified in step (a). At least one solvent may be used to compensate for the absence of ingredients in one coating composition as compared to the other provided coating compositions. In case of solvent-based coating compositions, the at least one solvent may be an organic solvent commonly used in solvent-based coating compositions, such as solvent naphtha. This approach avoids incompatibilities during preparation of the coating layer in the overspray region and thus reduces a negative influence on the overall appearance of the coated object.

In one example of this preferred embodiment, exactly two coating compositions C₁ and C₂ are provided, where one of the two provided coating compositions contains higher amounts of a flexible polyester resin to provide a coating layer having increased flexibility and stone chipping resistance but decreased chemical resistance while the other provided coating composition contains lower amounts of the flexible polyester resin to provide a coating layer having increased hardness and chemical resistance but decreased stone chipping resistance.

The coating compositions can be provided in step (b) in a number of ways. According to a first embodiment of step (b), step (b) includes
(b-1) providing at least two components (Aᵢ)_{i=1, . . . , n} having different properties and optionally at least one hardener component B,
(b-2) selecting mixing ratio(s) for at least part of the components Aᵢ provided in step
(b-1) to result in a coating layer CLᵢ having properties matching a set of properties identified in step (a),
(b-3) optionally selecting mixing ratio(s) for the at least one hardener component B provided in step (b-1), and
(b-4) mixing components Aᵢ, optionally with the at least one hardener component B in the mixing ratio(s) selected in step (b-2) and optionally (b-3) to provide the coating composition Cᵢ resulting in a coating layer CLᵢ having properties matching a set of properties identified in step (a).

The term “(Aᵢ)_{i=1, . . . , n}” denotes a sequence of components A, such as, for example A₁, A₂, A₃, . . . , Aₙ with n being the last member of the sequence. The term “component” refers to a single ingredient or a mixture of at least two ingredients.

Providing at least two coating compositions (Cᵢ)_{i=1, . . . , n} according to this embodiment may be preferred if the components (Aᵢ)_{i=1, . . . , n} provided in step (b-1) are not resulting—upon application—in respective coating layers matching a set of properties identified in step (a). This may be the case if the components provided in step (b-1) result in coating layers having properties which are too high/low compared to the properties required to match a set of properties identified in step (a), such as the position of the respective target areas on the object. To produce coating layers having properties matched to a set of properties identified in step (a), at least part of the components provided in step (b-1) have to be mixed.

The hardener component B preferably contains at least one crosslinking agent being capable of reacting with functional groups of a compound being present in at least one component A_{L}. Suitable crosslinking agents include the polyisocyanate compounds as described earlier. Use of the hardener component B during preparation of the coating compositions is generally optional and is only necessary if said coating compositions are 2K coating compositions being prepared from a base component (i.e. the mixture resulting from mixing the components (A₁, . . . , Aₙ) provided in step (b-1)) and at least one hardener component B. In 2K coating compositions, the components (A₁, . . . , Aₙ) provided in step (b-1) contain binder(s) having functional groups which are not self-reactive, or the amount/type of crosslinking agent(s) contained in the provided components (A₁, . . . , Aₙ) is too low to achieve sufficient crosslinking during curing of the applied coating composition.

In step (b-2), a mixing ratio for at least part of the components provided in step (b-1) is selected such that coating layers can be produced which have properties matching a set of properties identified in step (a). The properties of the coating layers can be predefined properties and may depend, for example, on the position of the target areas the respective coating composition is intended to be applied in step (c).

Step (b-2) may include determining the required properties of the respective coating layer and selecting a mixing ratio for at least part of the components provided in step (b-1) such that properties of the resulting coating layer CLᵢ which match a set of properties identified in step (a) are achieved upon application of the coating composition resulting from step (b-4) onto the respective target area of the object. Determining the properties of the coating layer may include determining the orientation and/or position of the target area(s) on the object to be coated with said coating composition in step (c) and selecting a mixing ratio resulting in properties of the coating layer being appropriate for the determined orientation and/or position. In one example, mixing ratios may be interrelated with components Aᵢ and a set of properties associated with a target area and may be provided to the user performing the inventive process in paper form or in electronic form. In another example, mixing ratios may be interrelated with components Aᵢ and a set of properties associated with a target area and may be stored in a database. A processing device having access to the database may determine appropriate mixing ratio(s) upon providing the determined set of properties of the target area(s) and an indication of the components Aᵢ (such as the formulation, a number being indicative of the components of components Aᵢ, etc.) to the processing device and display the determined mixing ratio(s) to the user or provide the determined mixing ratio to a mixing device to automatically mix the coating composition(s) based on the provided mixing ratio(s) and data on components A_{L}.

In one example, a higher fraction of components provided in step (b-1) and containing large amounts of a flexible polyester is selected in step (b-2) if a coating layer having a higher flexibility and stone chipping resistance is required. In another example, a lower fraction of components provided in step (b-1) and containing large amounts of a flexible polyester is selected in step (b-2) if a coating layer having a higher hardness and chemical resistance required. This allows to tune the properties of the resulting coating layers to the respective set of properties, such as the position, of the different target areas by selecting an appropriate mixing ratio between the at least two components provided in step (b-1). This allows to vary the properties of the coating layers depending on the respective set of properties of the target areas and allows, for example, to adjust the flexibility of the coating layer depending on the position of the target area(s) on the object. The variation of the mixing ratio to achieve the desired properties of the coating layer allows to produce a large number of coating layers having defined properties by providing only two components in step (b-1), namely a component comprising a binder and a component comprising a flexible polyester resin and/or a component increasing the scratch resistance and/or a component comprising light stabilizers. This allows to reduce the number of coating compositions which need to be stored to achieve comparative results in terms of overall mechanical and/or chemical properties of the coated object, thus reducing the need for extensive storage capacities.

The at least one component Aᵢ provided in step (b-1) may comprises at least one binder as previously described. With particular preference, each component (A₁, . . . , Aₙ) provided in step (b-1) comprises at least one binder, in particular at least one binder previously described. The at least one binder present in each provided component Aᵢ may be identical to at least one binder being present in the other provided components Aₙ₋ᵢ or the at least one binder being present in each provided component Aᵢ may be different from the binder(s) present in the other provided components Aᵢ. It may be beneficial if each component Aᵢ comprises at least one identical binder, i.e. each provided component Aᵢ contains at least one binder being identical to the binder(s) present in the other provided components Aₙ₋ᵢ. This increases the compatibility upon mixing of the provided components (A₁, . . . , Aₙ) in step (b-4) and thus reduces the occurrence of unwanted incompatibilities having a negative influence on the resulting properties of the coating layer resulting from step (c). Suitable binders and total amounts of binders are the binders and total amounts described previously.

The mixing ratios selected in step (b-2) and optional step (b-3) are preferably by volume. With preference, a volume:volume mixing ratio for the mixture of components Aᵢ and the at least one hardener component B of 8:1 to 1:1, preferably of 4:1 to 1:1 is selected in step (b-3). In case more than one hardener component B is provided in step (b-1), the aforementioned mixing ratios are valid for each hardener component provided in step (b-1). Use of these mixing ratios ensures a sufficient hardening of the resulting coating composition after application to the respective target area(s), thus avoiding a negative influence on the overall optical appearance due to insufficient hardening of the formed coating layer.

According to a second alternative embodiment of step (b), providing at least two coating compositions (Cᵢ)_{i=1, . . . , n} includes preparing the at least two different compositions (Cᵢ)_{i=1, . . . , n}, by mixing at least two coating material ingredients such that the coating layers (Cᵢ)_{i=1, . . . , n} resulting from the respective coating compositions each have properties matching a different set of properties identified in step (a). The term “coating material ingredients” refers to compounds commonly used to prepare coating materials, such as solvents, pigments, binders, additives, etc. The properties of the coating layers required for matching a set of properties identified in step (a) can be obtained by using commonly known flexible resins, modified binders, light stabilizers etc.

In one example, the coating material ingredients include
a base component BCᵢ, and
at least one hardener component B.

The base component may be selected such that the properties of the resulting coating layer match a set of properties identified in step (a). For example, the base component may comprise a high amount of flexible polyester resin to result in a coating layer having a high flexibility and thus a high stone chipping resistance. Said coating composition may be applied onto target areas requiring high stone chipping resistance. In another example, the base component may comprise low amounts of flexible polyester resin or may not comprise any flexible polyester to result in a coating layer having a high hardness and thus a high chemical resistance (but a low stone chipping resistance). Said coating composition may be applied onto target areas requiring high chemical resistance but low stone chipping resistance. In another example, the base component may comprise particles, such as SiO₂ particles and nanoparticles, to result in a coating layer having a scratch resistance. Said coating composition may be applied onto target areas requiring high scratch resistance. In another example, the base component may comprise low amounts of said particles or may not comprise any of said particles to result in a coating layer having a low scratch resistance. Said coating composition may be applied onto target areas requiring a low scratch resistance. In another example, the hardener component may be selected such that the properties of the resulting coating layer match a set of properties identified in step (a). For example, the hardener component B may comprise at least one compound containing one or more hydrolyzable silane groups to result in a coating layer having a high scratch resistance. Coating compositions prepared from said hardener B may be applied onto target areas requiring coating layers comprising a high scratch resistance. In another example, the hardener component B may be free of said compound containing one or more hydrolyzable silane groups to result in a coating layer having a lower scratch resistance. Coating compositions prepared from said hardener B may be applied onto target areas requiring coating layers comprising a low or lower scratch resistance.

The at least one base component BC, may be mixed with the at least one hardener component B in a volume:volume mixing ratio of 8:1 to 1:1, preferably of 4:1 to 1:1. Mixing of components Aᵢ, optionally with the hardener component(s) B, in step (b-4) or mixing of the base component BC, with the hardener component B to prepare the at least two coating compositions can be performed in numerous ways known in the state of the art.

In one example, each component Aᵢ is mixed, optionally with the hardener component(s) B, in the selected mixing ratios prior to supplying the resulting coating composition to an application equipment. In case the coating composition is prepared by mixing at least one base component BCᵢ with the at least one hardener component B, said at least one base component BCᵢ is mixed with the at least one hardener component B prior to supplying the resulting coating composition to an application equipment. The order of mixing the components (A₁, . . . , Aₙ) and optionally the hardener component B is not critical and can be varied. For example, components (A₁, . . . , Aₙ) can be mixed prior to mixing the obtained mixture with the hardener component B (if appropriate) or part of the components (A₁, . . . , Aₙ) can be mixed in a first step while mixing the remaining part of components (A₁, . . . , Aₙ) with the hardener component B in a second step or vice versa. Afterwards, the obtained mixtures from step 1 and 2 are combined. Mixing can either be performed manually or using commonly known mixing equipments. The reservoirs used for mixing can either be connected directly to the application equipment or the mixed coating compositions can be filled into respective reservoirs attached to an application equipment after the mixing operation. Suitable reservoirs include cans, containers etc., which are suitable to store coating compositions or parts thereof and which allow attachment to an application device, for example via a line. Preparing the coating compositions prior to applying them onto the target areas of the object may be preferred if steps (b) and (c) are performed sequentially.

In another example, the coating compositions are each obtained by mixing components Aᵢ, optionally with the hardener component(s) B, in the selected mixing ratios within an application equipment. In case the coating compositions are prepared by mixing at least one base component BCᵢ with the at least one hardener component B, said at least one base component BCᵢ is mixed with the at least one hardener component B within an application equipment. Mixing within an application equipment may be facilitated by attaching respective reservoirs containing the provided components (A, . . . , Aₙ) or the at least one base component BC, and optionally the hardener component B to the spraying equipment and mixing the attached components within the atomizer of the spraying equipment by providing the selected mixing ratio(s) and information on the components to be mixed to the spraying equipment. Mixing may also be facilitated by mixing at least part of the components Aᵢ or BCᵢ, with the hardener component B prior to supplying said mixture to the application equipment. In this case, the remaining components Aₙ₋ᵢ, optionally mixed with the hardener component B, or the hardener component B are supplied to the mixing equipment by additionally attaching reservoirs containing said remaining components to the application equipment. Suitable spraying equipments which allow attachment of at least two different reservoirs and mixing of the components present within at least two attached reservoirs within the atomizer include, for example, the commercially available EcoBell 3 2X2K from Durr. Preparation of the coating compositions within the application equipment avoids the use of a separate mixing device and allows to automatically control the mixing ratio to produce reproducible coating compositions. Performing mixing within the application equipment reduces the time span necessary to produce and apply the coating composition because steps (b) and (c) can be performed right after each other with only a minimal time difference between preparing the coating compositions and applying the prepared coating compositions, thus significantly reducing the overall time necessary to perform the inventive process. Additionally, the time for cleaning the application equipment compared to the use of different coating compositions is reduced because the same components are used to produce coating layers having different properties, rendering cleaning of the application equipment superfluous.

### Step (c):

In step (c) of the inventive process, the coating compositions provided in step (b) are applied onto target area(s) associated with the matching set of properties. Thus, each coating composition is applied in step (c) onto the target area(s) having a set of properties which match the properties of the coating layer resulting from application of the coating composition onto the target area of the object. A preferred property within the set of properties includes the position of the target areas on the object.

Application of the coating compositions in step (c) can be performed with any type of application equipment known to apply a coating composition to an object and may include, for example, dipping coating equipment, bar coating equipment, spraying equipment, rolling equipment or the like. With particular preference, step (b) is performed using a spray application equipment. Suitable spray application equipments include compressed air spraying equipments (pneumatic spraying equipment), airless spraying equipments, high-speed rotation equipments or electrostatic spray application equipments (ESTA), optionally in association with hot-spray, for example hot-air spraying equipments.

Each coating composition may be applied onto all target areas having the same set of matching properties or onto only a part of the target areas having the same set of matching properties. With preference, each coating composition is applied onto all target areas having the same set of matching properties. This avoids switching of the coating compositions during application, thus reducing cleaning times and material consumption. If a specific coating composition has only been applied to part of the target areas having the same set of properties in step (c), step (c) may be repeated for said coating composition with the proviso that said coating composition is applied to the remaining target areas having the same set of properties as the target areas to which said coating composition was applied in a step (c). Repetition of step (c) is generally optional and only needs to be performed in case only part of the target areas having the same set of properties were coated with a provided coating composition in step (c).

In one example, a coating composition resulting in coating layers having a high flexibility and thus a high stone chipping resistance is applied on target areas requiring high stone chipping resistance while a further coating composition resulting in coating layers having a high hardness and thus a low stone chipping resistance, but a high chemical resistance is applied on target areas requiring high chemical resistance but low stone chipping resistance. This allows to achieve an overall high mechanical, physical and/or chemical quality of the final coating because the properties of the coating layers are adjusted to the set of properties of the coated target areas. In another example, a coating composition resulting in coating layers having a high scratch resistance is applied on target areas requiring high scratch resistance while a further coating composition resulting in lower scratch resistance and thus being cheaper is applied on target areas requiring lower scratch resistance.

In yet another example, a coating composition resulting in coating layers having a high light resistance is applied on target areas requiring high light resistance while a further coating composition resulting in lower light resistance and thus being cheaper is applied on target areas requiring lower light resistance.

This allows to coat an object more efficiently in terms of costs and with a higher overall quality in terms of mechanical and/or chemical properties because the properties of the coating layers are adjusted to the set of properties of the coated target areas.

The application of the coating compositions is performed in such a way that each coating layer, after the curing in step (d), has a dry film thickness of, for example, 15 to 80 micrometers, preferably 20 to 65 micrometers, especially preferably 25 to 60 micrometers.

The process of this invention is suitable for coating a variety of metallic and non-metallic objects in a batch or continuous process. In a batch process, also referred to as a modular process, the object is stationary during each treatment step of the process, whereas in a continuous process the object is in continuous movement along the paint line in an assembly line fashion.

Suitable objects to be coated according to the method of the invention include (i) uncoated metal objects or metal objects being coated with a cured electrocoat layer and/or a cured filler layer and/or a non-cured basecoat layer; (ii) plastic objects optionally being coated with a cured primer layer and/or a non-cured basecoat layer; and (iii) objects comprising metallic and plastic parts and optionally being coated with a cured electrocoat layer and/or a cured filler layer and/or a cured primer-surfacer layer and/or a cured primer layer and/or a non-cured basecoat layer, preferably from metal objects being coated with a cured electrocoat layer and/or a cured filler layer and/or a non-cured basecoat layer, very preferably from metal objects being coated with a cured electrocoat layer and a non-cured basecoat layer. The objects preferably comprise areas having different orientations relative to each other, such as vertically oriented areas and horizontally oriented areas.

Suitable metal objects are selected from the group comprising or consisting of steel, iron, aluminum, copper, zinc and magnesium objects as well as objects made of alloys of steel, iron, aluminum, copper, zinc and magnesium.

Coated and uncoated metal objects can be pretreated in a manner known per se, i.e., for example, cleaned and/or provided with known conversion coatings. Cleaning can be performed mechanically, for example by means of wiping, grinding and/or polishing, and/or chemically by means of etching methods, such as surface etching in acid or alkali baths using, for example, hydrochloric acid or sulfuric acid, or by cleaning with organic solvents or aqueous detergents. Pretreatment by application of conversion coatings, especially by means of phosphation and/or chromation, preferably phosphation, may likewise take place. Preferably, the metallic objects are at least conversion-coated, especially phosphated, preferably by a zinc phosphation.

Metal objects being coated with a cured electrocoat are produced by electrophoretic application of an electrocoat material to the object and subsequent curing of the applied electrocoat material. The electrocoat material may be a cathodic or anodic electrocoat material, preferably a cathodic electrocoat material. Electrocoat materials are aqueous coating materials comprising anionic or cationic polymers as binders. These polymers contain functional groups which are potentially anionic, i.e. can be converted to anionic groups, for example carboxylic acid groups, or functional groups which are potentially cationic, i.e. can be converted to cationic groups, for example amino groups. The conversion to charged groups is generally achieved by the use of appropriate neutralizing agents (organic amines (anionic), organic carboxylic acids such as formic acid (cationic). The electrocoat materials generally comprise typical anticorrosion pigments. The cathodic electrocoat materials preferred in the context of the invention comprise preferably cationic polymers as binders, especially hydroxy-functional polyether amines, which preferably have aromatic structural units. These polymers are especially used in combination with blocked polyisocyanates known per se. The application of the electrocoating material proceeds by electrophoresis. For this purpose, the metallic workpiece to be coated is first dipped into a dip bath containing the coating material, and an electrical DC field is applied between the metallic workpiece and a counterelectrode. The workpiece thus functions as an electrode; the nonvolatile constituents of the electrocoat material migrate, because of the described charge of the polymers used as binders, through the electrical field to the object and are deposited on the object, forming an electrocoat film. For example, in the case of a cathodic electrocoat, the object is thus connected as the cathode, and the hydroxide ions which form there through water electrolysis neutralize the cationic binder, such that it is deposited on the object and forms an electrocoat layer. After the electrolytic application of the electrocoat material, the coated object is removed from the bath, optionally rinsed off with, for example, water-based rinse solutions, then optionally flashed off and/or intermediately dried, and finally cured. The dry film thickness of the cured electrocoat is, for example, 10 to 40 micrometers, preferably 15 to 25 micrometers.

Metal objects being coated with a cured filler layer are produced by applying a filler coating composition to the object, optionally flashing off and/or intermediately drying said applied composition and finally curing said composition. Suitable filler coating compositions are known in the state of the art. The dry film thickness of the cured filler layer is, for example, 10 to 40 micrometers, preferably 25 to 30 micrometers.

Metal objects being coated with a non-cured basecoat layer a produced by applying at least one basecoat composition to the object optionally being coated with at least one cured or non-cured coating layer and optionally flashing off and/or intermediately drying said applied basecoat composition. The dry film thickness of the cured basecoat layer is, for example, 5 to 40 micrometers, preferably 10 to 30 micrometers.

Preferred plastic objects are basically objects comprising or consisting of (i) polar plastics, such as polycarbonate, polyamide, polystyrene, styrene copolymers, polyesters, polyphenylene oxides and blends of these plastics, (ii) synthetic resins such as polyurethane RIM, SMC, BMC and (iii) polyolefin objects of the polyethylene and polypropylene type with a high rubber content, such as PP-EPDM, and surface-activated polyolefin objects. The plastics may furthermore be fiber-reinforced, in particular using carbon fibers and/or metal fibers.

Preferably, the objects to be coated according to the process of the present invention are used as components to fabricate vehicles, preferably automotive vehicles, including but not limited to automobiles, trucks, and tractors. The objects can have any shape, but are usually in the form of automotive body components such as bodies, hoods, doors, fenders, bumpers and/or trims for automotive vehicles. The invention is most useful in the context of coating automotive bodies and components thereof traveling in continuous movement along an automotive assembly line.

### Step (d):

The inventive method may further include a step (d) of curing, or drying and curing the coating compositions applied in step (c) to form at least two coating layers having adjustable properties. Curing or drying and curing may either be performed after applying all coating compositions to all target areas or after application of each coating composition to at least part of the target areas. Performing step (d) after application of all coating compositions to all target areas is more energy efficient because the curing operation requiring high temperatures is only performed once.

Drying can be performed at 15 to 35° C. for a period of 10 to 30 minutes. Curing is preferably performed at temperatures of 80 to 250° C., preferably of 80 to 180° C., for a period of 5 to 60 min, preferably 10 to 45 min. Curing conditions of this kind apply especially to the preferred case that the coating composition(s) are based on thermally curable 2K coating composition(s), since these conditions are necessary to achieve curing of such 2K coating composition(s).

The inventive process allows to match the properties of coating layers to the set of properties of respective target areas, for example to the position of the target areas on the object. This allows to achieve higher overall mechanical and/or chemical properties than producing a coating layer having balanced properties because properties like flexibility and hardness are conflicting properties which cannot be adjusted without negatively influencing each other. In principle, coating layers having adjustable properties can be obtained from coating compositions prepared by mixing only two components A₁ and A₂, for example a component comprising high amounts of a flexible polyester resin and a component comprising low or no amounts of said flexible polyester resin, in an appropriate mixing ratio, thus allowing to produce the coating layers having the required properties from a minimum number of components. This reduces the number of coating compositions which need to be stocked or attached to the application equipment, thus reducing the overall costs associated with the inventive process.

### Inventive Use:

A further subject-matter of the present invention is the use of the inventive process for preparing a coated object comprising target areas requiring coating layers having different properties.

Use of the inventive process results—as previously described—in higher overall mechanical and/or chemical properties of the coated object because the properties of the coating layers are matched to the set of properties of each target area, for example the position of each target area on the object.

What has been said about the process according to the invention applies mutatis mutandis with respect to further preferred embodiments of the inventive use.

### Inventive System:

A further subject matter of the present invention is a system for applying at least two coating compositions resulting in coating layers having adjustable properties to an object comprising a plurality of target areas, at least part of the plurality of target areas having a different set of properties. Each coating composition is applied onto target areas having a set of properties matching the properties of the respective coating composition. Hence, a coating composition is not applied onto target areas having different sets of properties.

The system comprises an application device comprising a nozzle, a storage device for storing application instructions and optionally mixing ratio instructions, one or more data processors configured to execute the application instructions and optionally the mixing ratio instructions to control the application device and at least two reservoirs in fluid communication with the application device comprising at least two components (Aᵢ)_{i=1, . . . , n} and optionally at least one hardener component B or at least two coating compositions (Cᵢ)_{i=1, . . . , n}. Each component Aᵢ or each mixture of one or more components and B results in a coating layer CLᵢ has properties matching a set of properties of target area(s). As previously mentioned with respect to step (b) of the inventive method, at least part of the components Aᵢ may already be mixed with the binder component B such that the reservoir may contain component Aᵢ and binder B.

In one embodiment of the system, the application device is configured to receive one or more components Aᵢ and optionally B from the reservoir and to mix the received one or more components Aᵢ optionally with B based on the mixing ratio instructions within the nozzle. Mixing may result in preparation of clearcoat compositions (C₁, . . . , Cₙ). Mixing may result in the preparation of at least two clearcoat compositions (C₁, . . . , Cₙ) resulting in coating layers having different properties. Afterwards, the resulting coating compositions (Cᵢ)_{i=1, . . . , n} are expelled through the nozzle based on the application instructions to target coating area(s) having a matching set of properties. The application instructions may be associated with mixing instructions used to prepare the respective coating composition Cᵢ. This allows to ensure that the properties of the coating layer resulting from expelling—according to the application instructions—the respective coating composition Cᵢ prepared according to the mixing instructions match the set of properties of the target area(s) the respective coating composition C, is expelled to. This embodiment is preferred if the coating compositions to be expelled onto the target areas need to be generated from at least two different components and a separate mixing step outside of the application device should be avoided.

In an alternative embodiment of the system, the application device is configured receive at least two coating compositions (Cᵢ)_{i=1, . . . , n} from the reservoir and to expel the coating compositions (Cᵢ)_{i=1, . . . , n} based on the application instruction through the nozzle to target area(s) having a matching set of properties. This embodiment may be preferred if coating compositions resulting in coating layers having properties required to match the set of properties of the respective target area(s) are used.

In both embodiments, the same coating composition is not expelled onto target areas having a different set of properties, i.e. a coating composition resulting in a coating layer having defined properties is only expelled to target areas having a matching set of properties and not onto target areas having a non-matching set of properties. This allows to produce a coating layer having properties matching a set of properties of the target areas, such as the position of the target areas on the object.

Suitable application devices include the spray application devices previously mentioned in relation to step (c) of the inventive process.

The storage device stores application instructions and optionally mixing ratio instructions. The application instructions may include location data associated with each target areas (target area location data). The application instructions may further include property data associated with the set of properties of at least part of the target areas. The mixing ratio instructions may include mixing ratio data associated with component data. Mixing ratio data may include the mixing ratio of different components A and optionally hardener B. Mixing ratio data may include property data associated with the property of the resulting coating layer. Said property data may be interrelated with the respective mixing ratio of component(s) A and B. Component data may include a component name and/or a component identifier. The application instructions may be associated with the mixing ratio instructions. This may include interrelating target area location data with the respective mixing ratio data. Associating the application instructions with the mixing instructions ensures that the correct coating composition is applied to the correct target area(s), e.g. that a coating composition resulting in a coating layer having properties matching the set of properties of target area(s) is applied onto said target area(s). Said instructions are computer-executable instructions which allow the computer processors to control the mixing and expelling process performed by the application device. Hence, the application instructions and optionally mixing ratio instructions may be regarded as control data used to control the application device. The control data may be generated by the one or more computer processors. The control data may be generated by a further computing unit and may be provided to the one or more computer processors for control of the application device based on the provided control data.

The one or more computer processors may be present within a computing system as previously described in relation to step (a). The computing system may further comprise the storage device previously described. The processors of the computing system are configured to execute the application instructions and optionally the mixing ratio instructions and to control the application device upon executing said instructions.

The reservoirs may be any container which is suitable for containing a coating composition or parts thereof and which can be connected to the application device such that the application device can receive the components present within the respective reservoir. Connection between the reservoir and the application device may be facilitated using a line.

In an aspect, the one or more data processors are further configured to generate the application instructions by:
receiving, by the one or more data processors, target image data of the object, the target image data including a plurality of target areas,
generating, based on the received image data, the application instructions.

The target image data of the object may be provided to the data processors from a storage device, such as a database. Retrieval of the data may be performed by entering data being indicative of the object, such as the vehicle identification number, a unique ID, etc. and retrieving the data based on the entered data. In one example, target image data may be an image of the object. In another example, the target image data may be CAD data of the object. The application instructions may be generated by determining the properties, in particular the properties and location(s), of said target areas and generating application instructions based on said determined properties, in particular based on the determined properties and location(s). Determining the properties may be performed based on indications being present in the provided target image data.

In an aspect, the one or more data processors are further configured to generate mixing instructions by
obtaining application instructions including property data associated with the set of properties of at least part of the target areas,
obtaining data associated with the components used to prepare the coating compositions to be applied, and
determining the mixing ratio instructions based on the application instructions, in particular based on the property data associated with the set of properties of at least part of the target areas contained in the application instructions.

Data associated with the components may include mixing ratio data interrelated with properties of resulting coating layer(s). Data associated with the components may further include the component name(s) and/or the component identifier(s). Mixing instructions may be determined by mapping the properties contained in the data associated with the components with matching sets of properties contained in the property data included in the application instructions and determining the mixing ratio(s) associated with the mapped properties.

The inventive system may be used perform the process of the invention.

What has been said about the process according to the invention and the use of the invention applies mutatis mutandis with respect to further preferred embodiments of the inventive system.

The invention is described in particular by the following embodiments:
1. Process for preparing an object comprising a plurality of target areas, at least part of the plurality of target areas having a different set of properties, and being coated with at least two coating layers having adjustable properties, said process comprising
   (a) identifying at least two target areas and the set of properties associated with each identified target area, wherein at least two target areas have a different set of properties,
   (b) providing at least two different coating compositions (Cᵢ)_{i=1, . . . , n} wherein each coating composition (C₁, . . . , Cₙ) results in a coating layer (CL₁, . . . , CLₙ) having properties matching a different set of properties identified in step (a), and
   (c) applying each coating composition (C₁, . . . , Cₙ) provided in step (b) onto the target area(s) associated with the matching set of properties.
2. Process according to embodiment 1, wherein the adjustable properties include the hardness, the scratch resistance, the light resistance, the appearance and/or the adhesion.
3. Process according to embodiment 1 or 2, wherein the different set of properties identified in step (a) includes a different orientation of respective target areas relative to each other and/or a different position of the respective target areas on the object.
4. Process according to any one of the preceding embodiments, wherein step (a) includes at a computing device with a display and one or more user input devices adapted to detect user input:
   (a-1) displaying a user interface comprising the object on the display,
   (a-2) detecting a user input being indicative of identifying at least two target areas and the set of properties associated with each target area on the object,
   (a-3) determining the target areas and each set of properties associated with each identified target area based on the detected user input, and
   (a-4) providing the data determined in step (a-3) to an application equipment and/or display the data determined in step (a-3) within the user interface.
5. Process according to embodiment 1, wherein step (a) includes providing a user interface containing an object, said object comprising at least two marked target areas and an indication to the set of properties associated with the marked target areas.
6. Process according to embodiment 1, wherein step (a) includes visually determining at least two target areas and the set of properties associated with each identified target area, wherein at least two target areas have a different set of properties.
7. Process according to any one of the preceding embodiments, wherein each provided coating composition (C₁, . . . , Cₙ) is a liquid solvent- or water-based coating composition, preferably a liquid solvent-based coating composition.
8. Process according to any one of the preceding embodiments, wherein each provided coating composition (C₁, . . . , Cₙ) is transparent, semi-transparent or opaque, in particular transparent.
9. Process according to any one of the preceding embodiments, wherein at least one provided coating composition Cᵢ results in a coating layer CLᵢ having a high stone chip resistance and at least one further provided coating composition Cₙ₋ᵢ results in a coating layer CLₙ₋ᵢ having a high chemical resistance and/or wherein at least one provided coating composition Cᵢ results in a coating layer CLᵢ having a high scratch resistance and at least one further provided coating composition Cₙ₋ᵢ results in a coating layer CLₙ₋ᵢ having a lower scratch resistance and/or wherein at least one provided coating composition Cᵢ results in a coating layer CLᵢ having a high light resistance and at least one further provided coating composition Cₙ₋ᵢ results in a coating layer CLₙ₋ᵢ having a lower light resistance.
10. Process according to any one of the preceding embodiments, wherein each provided coating composition (C₁, . . . , Cₙ) comprises at least one binder, said at least one binder being identical to at least one binder being present in the other provided coating compositions or wherein each provided coating composition comprises at least one binder being different from the binder(s) present in the other provided coating compositions.
11. Process according to embodiment 10, wherein the at least one binder is selected from (i) poly(meth)acrylates, more particularly hydroxy-functional and/or carboxylate-functional and/or amine-functional poly(meth)acrylates, (ii) polyurethanes, more particularly hydroxy-functional and/or carboxylate-functional and/or amine-functional polyurethanes, (iii) polyesters, more particularly polyester polyols, (iv) polyethers, more particularly polyether polyols, (v) copolymers in the stated polymers, and (vi) mixtures thereof, in particular from hydroxy-functional poly(meth)acrylates and/or polyesters.
12. Process according to embodiment 11, wherein the hydroxy-functional (meth)acrylate contains—in polymerized form—at least one unsaturated monomer comprising at least one acid group M1, at least one unsaturated aliphatic and/or cycloaliphatic monomer M2, at least one unsaturated aromatic monomer M3 and at least one unsaturated hydroxy-group containing monomer M4.
13. Process according to embodiment 12, wherein the at least one unsaturated monomer comprising at least one acid group M1 is selected from (meth)acrylic acid.
14. Process according to embodiment 12 or 13, wherein the at least one unsaturated aliphatic monomer M2 is selected from alkyl (meth)acrylates, more preferably from C₁-C₂₂ alkyl (meth)acrylates, even more preferably from C₁-C₁₄ alkyl (meth)acrylates such as C₃ alkyl (meth)acrylates, C₄ alkyl (meth)acrylates, C₅ alkyl(meth)acrylates, C₆ alkyl (meth)acrylates, C₇ alkyl (meth)acrylates and C₁₃ alkyl (meth)acrylates, very preferably from butyl (meth)acrylate and/or (meth)acrylic ester 13.0.
15. Process according to any one of embodiments 12 to 14, wherein the at least one unsaturated cycloaliphatic monomer M2 is selected from cycloalkyl (meth)acrylate, preferably from cyclo-C₅-C₇-alkyl (meth)acrylate, in particular from cyclohexyl (meth)acrylate.
16. Process according to any one of embodiments 12 to 15, wherein the at least one unsaturated aromatic monomer M3 is selected from styrene.
17. Process according to any one of embodiments 12 to 16, wherein the at least one unsaturated hydroxy-group containing monomer M4 is selected from hydroxyl group-containing (meth)acrylates, more preferably from hydroxy C₁-C₁₂ alkyl group-containing (meth)acrylates, even more preferably selected from 2-hydroxyethyl (meth)acrylate, 2-hydroxyisopropyl (meth)acrylate, 3-hydroxypropyl (meth)acrylate, hydroxyisobutyl (meth)acrylate and 4-hydroxybutyl (meth)acrylate, very preferably from 2-hydroxyethyl (meth)acrylate and 3-hydroxypropyl (meth)acrylate.
18. Process according to any one of embodiments 10 to 17, wherein the at least one binder is present in each provided coating composition (C₁, . . . , Cₙ) in a total amount of 10 to 70 wt.-%, preferably of 20 to 65 wt.-%, more preferably 30 to 60 wt.-%, very preferably of 40 to 50 wt.-%, based in each case on the total weight of the provided coating composition C.
19. Process according to any one of the preceding embodiments, wherein each provided coating composition (C₁, . . . , Cₙ) comprises at least one crosslinking agent, said at least one crosslinking agent being identical to at least one crosslinking agent being present in the other provided coating compositions or wherein each provided coating composition (C₁, . . . , Cₙ) comprises at least one crosslinking agent being different from the crosslinking agent(s) present in the other provided coating compositions.
20. Process according to embodiment 19, wherein the at least one crosslinking agent is capable of reacting with functional groups of at least one compound being present in the coating composition Cᵢ.
21. Process according to embodiment 19 or 20, wherein the at least one crosslinking agent comprises aminoplast resins and/or polyisocyanates, preferably aminoplast resins and aliphatic or cycloaliphatic polyisocyanates, very preferably aminoplast resins and hexamethylene diisocyanate and/or dimerized and/or trimerized hexamethylene diisocyanate.
22. Process according to any one of the preceding embodiments, wherein at least one coating composition Cᵢ provided in step (b) further comprises at least one sagging control agent (SCA), in particular at least one polymeric sagging control agent.
23. Process according to embodiment 22, wherein the polymeric sagging control agent (SCA) is obtained by reacting a primary or secondary amine, in particular benzyl amine, with an isocyanate compound, in particular with a polyisocyanate, in the presence of a hydroxy-functional poly(meth)acrylate.
24. Process according to embodiment 23, wherein the hydroxy-functional poly(meth)acrylate contains—in polymerized form—at least one unsaturated monomer comprising at least one acid group M1, at least one unsaturated aliphatic monomer M2, at least one unsaturated aromatic monomer M3 and at least one unsaturated hydroxy-group containing monomer M4.
25. Process according to any one of embodiments 22 to 24, wherein the polymeric sagging control agent has an average molecular weight Mw of 3,000 to 50,000 g/mol, preferably of 4,000 to 30,000 g/mol, very preferably of 5,000 to 15,000 g/mol, as determined with GPC using polystyrene as internal standard.
26. Process according to any one of embodiments 22 to 25, wherein the sagging control agent (SCA) is present in coating compositions requiring a higher sagging resistance.
27. Process according to any one of embodiments 22 to 26, wherein the sagging control agent (SCA), in particular the polymeric sagging control agent, is present in a total amount of 0.1 to 40 wt.-%, preferably of 2 to 30 wt.-%, more preferably of 3 to 20 wt.-%, very preferably of 4 to 15 wt.-%, based in each case on the total weight of the respective provided coating composition Cᵢ.
28. Process according to any one of the preceding embodiments, wherein at least one provided coating composition further comprises at least one additive being different from the sagging control agent (SCA).
29. Process according to embodiment 28, wherein the at least one additive being different from the sagging control additive is selected from light stabilizers, leveling agents, UV absorbers, pigments, free-radical scavengers, slip additives, polymerization inhibitors, defoamers, wetting agents, adhesion promoters, flow control agents, film-forming assistants such as cellulose derivatives, fillers, rheology control additives, flame retardants and/or water scavengers, in particular light stabilizers and leveling agents.
30. Process according to embodiment 29, wherein the leveling agents are selected from silicon-containing leveling agents.
31. Process according to any one of the preceding embodiments, wherein each provided coating composition (C₁, . . . , Cₙ) only differs in the amount and/or type of ingredient(s) necessary to achieve properties of the respective resulting coating layer (C₁, . . . , Cₙ) which are matching a set of properties identified in step (a).
32. Process according to any one of the preceding embodiments, wherein step (b) includes
   (b-1) providing at least two components (Aᵢ)_{i=1, . . . , n} having different properties and optionally at least one hardener component B,
   (b-2) selecting mixing ratio(s) for at least part of the components Aᵢ provided in step (b-1) to result in a coating layer CLᵢ having properties matching a set of properties identified in step (a),
   (b-3) optionally selecting mixing ratio(s) for the at least one hardener component B provided in step (b-1), and
   (b-4) mixing components Aᵢ, optionally with the at least one hardener component B in the mixing ratio(s) selected in step (b-2) and optionally (b-3) to provide the coating composition Cᵢ resulting in a coating layer CLᵢ having properties matching a set of properties identified in step (a).
33. Process according to embodiment 32, wherein step (b-2) includes determining the required properties of the coating layer CLᵢ and selecting a mixing ratio for at least part of the components provided in step (b-1) such that properties of the resulting coating layer CLᵢ which match a set of properties identified in step (a) are achieved.
34. Process according to embodiment 32 or 33, wherein the mixing ratios selected in step (b-2) and optional step (b-3) are by volume and/or wherein a volume:volume mixing ratio for the mixture of components Aᵢ and the at least one hardener component B of 8:1 to 1:1, preferably of 4:1 to 1:1 is selected in step (b-3).
35. Process according to any one of embodiments 1 to 31, wherein step (b) includes preparing the at least two different compositions (Cᵢ)_{i=1, . . . , n} by mixing at least two coating material ingredients such that the coating layers (Cᵢ)_{i=1, . . . , n} resulting from the respective coating compositions each have properties matching a different set of properties identified in step (a).
36. Process according to embodiment 35, wherein the coating material ingredients include
   a base component BC_{L}, and
   at least one hardener component B.
37. Process according to embodiment 36, wherein a volume:volume mixing ratio of 8:1 to 1:1, preferably of 4:1 to 1:1 is used for mixing the base component BCᵢ with the at least one hardener component B.
38. Process according to any one of embodiments 32 to 36, wherein components Aᵢ are mixed, optionally with the hardener component(s) B, in the selected mixing ratios prior to supplying the resulting coating composition Cᵢ to an application equipment and/or wherein the at least one base component BCᵢ is mixed with the at least one hardener component B prior to supplying the resulting coating composition Cᵢ to an application equipment.
39. Process according to any one of embodiments 32 to 36, wherein each coating composition Cᵢ is obtained by mixing components Aᵢ, optionally with the hardener component(s) B, in the selected mixing ratios within an application equipment and/or wherein the at least one base component BCᵢ is mixed with the at least one hardener component B within an application equipment.
40. Process according to any one of the preceding embodiments, wherein step (c) is performed using a spray application equipment.
41. Process according to any of the preceding embodiments, wherein each provided coating composition (C₁, . . . , Cₙ) is applied onto all target areas having the same set of properties.
42. Process according to any one of the preceding embodiments, further including a step (d) of curing or drying and curing the applied the coating composition(s).
43. Use of the process according to any one of the preceding embodiments for preparing a coated object comprising target areas requiring coating layers having different properties.
44. A system for applying—utilizing an application device—at least two coating compositions resulting in coating layers having adjustable properties to an object comprising a plurality of target areas, at least part of the plurality of target areas having a different set of properties, the system comprising:
   an application device comprising a nozzle;
   a storage device for storing application instructions and optionally mixing ratio instructions;
   one or more data processors configured to execute the application instructions and optionally the mixing ratio instructions to control the application device; and
at least two reservoirs in fluid communication with the application device and configured to contain at least two components (Aᵢ)_{i=1, . . . , n} and optionally at least one hardener component B, each component Aᵢ or each mixture of Aᵢ and B resulting in a coating layer CLᵢ having properties matching a set of properties of target area(s), or configured to contain at least two coating compositions (Cᵢ)_{i=1, . . . , n} resulting in coating layer (CLᵢ)_{i=1, . . . , n} each coating layer CLᵢ having properties matching a set of properties of target area(s),
wherein the application device is configured to
   receive the components (Aᵢ)_{i=1, . . . , n} and optionally the hardener component B from the reservoir and to mix the components (optionally with the hardener component B based on the mixing ratio instructions within the nozzle, and
   to expel the resulting coating compositions (Cᵢ)_{i=1, . . . , n} based on the application instruction through the nozzle to target area(s) having a matching set of properties to form at least two coating layers; or
wherein the applicator is configured to
   receive the at least two coating compositions (Cᵢ)_{i=1, . . . , n} from the reservoir, and
   to expel the coating compositions (based on the application instruction through the nozzle to target area(s) having a matching set of properties to form at least two coating layers.
45. The system according to claim 44, wherein the one or more data processors are further configured to generate the application instructions by:
   receiving, by the one or more data processors, target image data of the object, the target image data including the different target areas,
   generating, based on the received image data, the application instructions.

### DESCRIPTION OF THE DRAWINGS

FIG. 1 shows a schematical drawing of a vehicle 100 to be coated with a coating material. In this example, the coating material is a clearcoat material. In another example, the coating material is a primer coating material, a primer-surfacer coating material, a filler coating material or a basecoat material. The vehicle 100 contains target areas 102 positioned on top of the vehicle as well as target areas 104 positioned on the side of the vehicle. Using the inventive process, a coating layer having a high hardness and chemical resistance (i.e. a low flexibility) is produced on target areas 102 positioned on top of the vehicle while a coating layer having a high flexibility and stone chipping resistance (i.e. a high hardness) is produced on target areas 104 positioned on the side of the vehicle. For this purpose, a coating material resulting in a coating layer having a high flexibility, for example by containing suitable amounts of a flexible polyester resin, is applied onto target areas 104 while a coating material resulting in a coating layer having a high hardness, for example by containing lower amounts of or no flexible polyester resin, is applied onto target areas 102. The coating material applied onto target area 102 may, for example, be obtained by using a component Aᵢ containing high amounts of flexible polyester, and a component Aᵢ₊₁ containing no flexible polyester. The coating material resulting in a coating layer having a lower flexibility can then be obtained by mixing the components Aᵢ, Aᵢ₊₁ in a suitable mixing ratio.

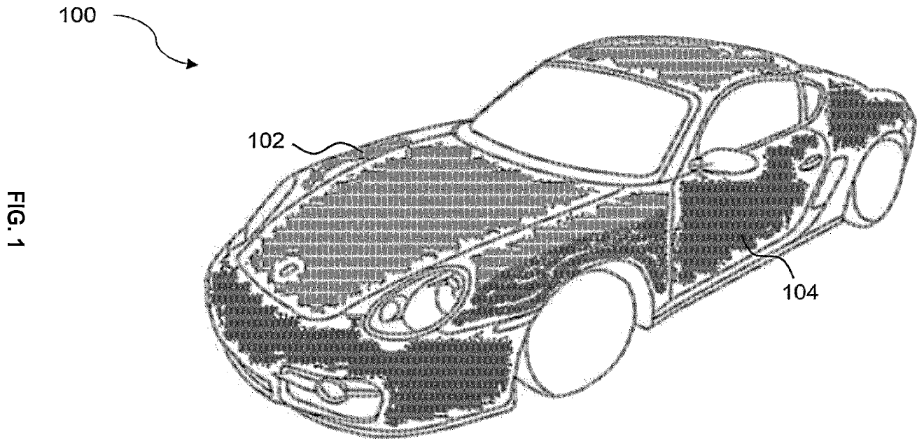

### EXAMPLES

The present invention will now be explained in greater detail using working examples, but the present invention is in no way limited to these working examples. Moreover, the terms “parts”, “%” and “ratio” in the examples denote “parts by mass”, “mass %” and “mass ratio” respectively unless otherwise indicated.

### A) Methods of Determination:

### 1. Solids Content (Solids, Nonvolatile Fraction)

Unless otherwise indicated, the solids content, also referred to as solid fraction hereinafter, was determined in accordance with DIN EN ISO 3251:2008-06 at 130° C. and 60 min, initial mass 1.0 g.

### 2. Determination of Chemical Resistance (Gradient Oven Method)

For the determination of the chemical resistance, multicoat paint systems were produced according to the following general protocol: A steel panel (10×50 cm) coated with a cured cathodic electrodeposition paint (Cathoguard® 800 from BASF Coatings GmbH) and a cured commercially available water-based basecoat material (ColorBrite from BASF Coatings GmbH) was electrostatically coated with the respective clearcoat composition in a target film thickness (film thickness of the dried material) of 40 μm±5 μm in a single application. After a flash time of 10 minutes at room temperature (25° C.), the resulting clear coating film was cured in a forced air oven at 125° C. for 20 minutes or at 160° C. for 30 minutes.

Determination of the chemical resistance was determined by means of a customary and known gradient oven test. For this purpose sulfuric acid solution (1 wt.-%), pancreatin, tree resin, and sodium hydroxide solution (1 wt.-%) were applied to the surface of the respective multicoat paint system. The test panels were placed in a preheated gradient oven for 30 minutes. After heating, the test panels were rinsed off with water and washing-gasoline and a determination was made in each case of the temperature reached before there were any visible signs of damage to the paint surface.

### 3. Determination of Hardness

The microintendation hardness was determined according to DIN EN ISO 14577-4 on multicoat paint systems prepared as described in relation to point 2. Above with the following deviation: the resulting clearcoating film was cured in a forced air oven at 140° C. for 20 minutes.

### 4. Determination of Stonechip Resistance

For the determination of the stonechip resistance, multicoat paint systems were produced according to the following general protocol:

A steel panel (10×20 cm) coated with a cured cathodic electrodeposition paint (Cathoguard® 800 from BASF Coatings GmbH) and a cured commercially available water-based basecoat material (ColorBrite from BASF Coatings GmbH) was electrostatically coated with the respective clearcoat composition in a target film thickness (film thickness of the dried material) of 40 μm±5 μm in a single application. After a flash time of 10 minutes at room temperature (25° C.), the resulting clear coating film was cured in a forced air oven at 160° C. for 30 minutes.

The resulting multicoat paint systems were tested for their stonechip resistance. This was done using the stonechip test of DIN 55966-1:2001-04. The results of the stonechip test were assessed in accordance with DIN EN ISO 20567-1:2017-07. Lower values represent better stonechip resistance.

### B) Preparation of Different Clearcoat Coating Compositions

1. Preparation of Base Components BC Each base component BC₁ and BC₂ was prepared by mixing the components given in Table 1. Base component BC₁ contains a low amount of a flexible polyester resin while base component BC₂ contains a higher amount of a flexible polyester resin.

TABLE 1
Ingredients to prepare the base component
BC₁ and BC₂ (all amounts are given in % by weight)

| Ingredients | BC₁ | BC₂ |
|---|---|---|
| (Meth)acrylic resin 1 ¹⁾ | 48.2 | 42.2 |
| Polymeric sagging additive ²⁾ | 19 | 19 |
| Setal ® 1715 ³⁾ | 2.0 | 8.0 |
| SETAMINE US-138 BB-70 ⁴⁾ | 9.3 | 9.3 |
| CYMEL 303 LF Resin ⁵⁾ | 2.0 | 2.0 |
| UV-Absorber 1130 ⁶⁾ | 1.3 | 1.3 |
| HALS 292 ⁷⁾ | 1.0 | 1.0 |
| BYK-325 N ⁸⁾ | 0.20 | 0.20 |
| BYK 315 N ⁹⁾ | 0.03 | 0.03 |
| Butylglycol acetate | 1.0 | 1.0 |
| Xylene | 0.97 | 0.97 |
| Flowlen AC 300 ¹⁰⁾ | 0.04 | 0.04 |
| Xylene | 3.6 | 3.6 |
| Butylglycol acetate | 4.8 | 4.8 |
| Butyldiglycol acetate | 0.8 | 0.8 |
| Butanol | 5.8 | 5.8 |

¹⁾ the hydroxy-functional (meth)acrylic resin contains the following monomers: styrene, hydroxyethyl methacrylate, hydroxypropyl methacrylate, butyl methacrylate, cyclohexyl methacrylate and acrylic acid, solids content = 56%,
²⁾ prepared according to the procedure described under “Herstellung eines erfindungsgemaßen SCA Harzes” on page 18, lines 5 to 26 of WO2008148555A1,
³⁾ saturated polyester having an OH content of 4.4%, based on solids, a solids content of 71-73%, an acid number of from 6.5 to 9.8, a viscosity from 4.0 to 5.8 Pas at 23° C. and 100 s⁻¹ (supplied by Allnex);
⁴⁾ n-butylated high imino melamine crosslinker, solids content = 68-72% (supplied by Allnex);
⁵⁾ highly methylated, monomeric melamine crosslinker, solids content = ≥98% (supplied by Allnex);
⁶⁾ liquid UV absorber of the hydroxyphenyl benzotriazole class (supplied by BASF Dispersions & Resins);
⁷⁾ liquid hindered amine light stabilizer (Tinuvin ® 292) (supplied by BASF Dispersions & Resins);
⁸⁾ polyether-modified polymethylalkylsiloxane, solid content = 52% (supplied by BYK-Chemie GmbH);
⁹⁾ polyester-modified polymethylalkylsiloxane, solid content = 25% (supplied by BYK-Chemie GmbH);
¹⁰⁾ Acrylic polymer/ polyvinylether, solid content = 77% (supplied by Kyoeisha Chemical)

### 2. Preparation of the Hardener Component

The hardener component B was prepared by mixing the components given in Table 2:

TABLE 2
Ingredients to prepare the hardener component B

| Ingredients | Amount [wt.- %] |
|---|---|
| Polyisocyanate ¹⁾ | 89.6 |
| Solventnaphtha 160/180 | 5.2 |
| Butylacetate | 5.2 |

¹⁾ Desmodur Ultra N 3390 BA/SN, solid content = 90% (supplied by Covestro AG)

### 3. Preparation of Different Clearcoat Coating Compositions

The clearcoat compositions CC1 and CC2 were each prepared by mixing the respective base component BC₁ or BC₂ with the hardener component B in the mixing ratios given in Table 3.

TABLE 3
Clearcoat compositions CC1 and CC1

| Clearcoat composition | Base component | Mixing ratio BC:B |
|---|---|---|
| CC1 | BC₁ | 100:33 |
| CC2 | BC₂ | 100:33 |

### C) Preparation of Coated Objects

Test panels for evaluation of chemical resistance, hardness and stonechip resistance were prepared as described in point A) above.

### D) Results

### 1. Chemical Resistance

The chemical resistance of multicoat system MC1 comprising clearcoat composition CC1 and multicoat system MC2 comprising clearcoat composition CC2 was determined as previously described. The obtained results are listed in Tables 4 and 5. In the upper half of this table, only the differences with regard to the ingredients of clearcoats CC1 and CC2 are listed. The footnote 1) is corresponding to footnote 1) of Table 1.

TABLE 4
Results of chemical resistance for multicoat system MC1
and MC2 (clearcoats were cured at 125° C. for 20
minutes, beginning of damage after 30 minutes at ° C.)

| | | |
|---|---|---|
| Ingredient | MC1 | MC2 |

| | | | | |
|---|---|---|---|---|
| Setal ® 1715 ³⁾ | 2 | wt.-% | 8 | wt.-% |
| Sulfuric acid solution | 44° | C. | 43° | C. |
| Sodium hydroxide solution | 42° | C. | 40° | C. |
| Pancreatin | <36° | C. | <36° | C. |
| Tree resin | 41° | C. | <36° | C. |

TABLE 5
Results of chemical resistance for multicoat system
MC1 and MC2 (clearcoats were cured at 160° C.
for 30 minutes, beginning of damage after 24 hours at ° C.)

| | | |
|---|---|---|
| Ingredient | MC1 | MC2 |

| | | | | |
|---|---|---|---|---|
| Setal ® 1715 ³⁾ | 2 | wt.-% | 8 | wt.-% |
| Sulfuric acid solution | 46° | C. | 43° | C. |
| Sodium hydroxide solution | 48° | C. | 46° | C. |
| Pancreatin | <36° | C. | <36° | C. |
| Tree resin | 50° | C. | 42° | C. |

### 2. Microintendation Hardness

The hardness of multicoat system MC1 comprising clearcoat CC1 and multicoat system MC2 comprising clearcoat composition CC2 was determined as previously described. The obtained results are listed in Table 6. In the upper half of this table, only the differences with regard to the ingredients of clearcoats CC1 and CC2 are listed. The footnote 1) is corresponding to footnote 1) of Table 1.

TABLE 6
Results of hardness measurement
for multicoat systems MC1 and MC2

| | | |
|---|---|---|
| Ingredient | MC1 | MC2 |

| | | | | |
|---|---|---|---|---|
| Setal ® 1715 ³⁾ | 2 | wt.-% | 8 | wt.-% |
| Microintendation hardness | 137 | N/mm² | 127 | N/mm² |

### 3. Stonechip Resistance

The stonechip resistance of multicoat system MC1 comprising clearcoat composition CC1 and multicoat system MC2 comprising clearcoat composition CC2 was determined as previously described. The obtained results are listed in Table 7. In the upper half of this table, only the differences with regard to the ingredients of clearcoats CC1 and CC2 are listed. The footnote 1) is corresponding to footnote 1) of Table 1. Moreover, the term “no repair” refers to the multicoat paint system prepared as described in point 4. while the term “repair” refers to a multicoat paint system prepared according to point 4, which has been repaired as described in the table prior to performing the stone chipping test.

TABLE 7
Results of stonechip resistance for multicoat systems
MC1 and MC2 (substrate temperatures used for stone-
chipping test are given in square brackets)

| Ingredient | MC1 | MC2 |
|---|---|---|
| Setal ® 1715 ³⁾ | 2 wt.-% | 8 wt.-% |
| No repair [23° C.] | 1 | 0.5 |
| No repair [−20° C.] | 1.5 | 1 |
| Repair BC/CC no sanding [23° C.] | 1.5 | 1 |
| Repair BC/CC no sanding [−20° C.] | 1.5 | 1.5 |
| Repair CC only with sanding [23° C.] | 1 | 1 |
| Repair CC only with sanding [−20° C.] | 1.5 | 1 |

### E) Discussion of the Results

A better chemical resistance is obtained for coating layers prepared from coating compositions comprising lower amounts of flexible polyester (CC1). Said coating layers also comprise a higher hardness. However, said coating layers result in a reduced stonechip resistance (see Table 7) as compared to more flexible coating layers prepared from coating composition comprising higher amounts of flexible polyester resin (CC2). The latter coating layers however, comprise a lower chemical resistance due to their higher flexibility.

The results demonstrate that the production of coating layers having adjustable properties allows to avoid balancing conflicting properties, such as flexibility and hardness, but instead allows to coat the respective target areas with a coating layer having properties optimized to the set of properties of said respective target areas to achieve higher overall mechanical and/or chemical properties.

1. A process for preparing an object comprising a plurality of target areas, at least part of the plurality of target areas having a different set of properties, and being coated with at least two coating layers having adjustable properties, said process comprising:
(a) identifying at least two target areas and the set of properties associated with each identified target area, wherein at least two target areas have a different set of properties,
(b) providing at least two different coating compositions (Cᵢ)_{i=1, . . . , n} wherein each coating composition (C₁, . . . , Cₙ) results in a coating layer (CL₁, . . . , CLₙ) having properties matching a different set of properties identified in step (a), and
(c) applying each coating composition (C₁, . . . , Cₙ) provided in step (b) onto the target area(s) associated with the matching set of properties.

2. The process according to claim 1, wherein each provided coating composition (C₁, . . . , Cₙ) is a liquid solvent- or water-based coating composition.

3. The process according to claim 1, wherein at least one provided coating composition Cᵢ results in a coating layer CLᵢ having a high stone chip resistance and at least one further provided coating composition Cₙ₋ᵢ results in a coating layer CLₙ₋ᵢ having a high chemical resistance and/or wherein at least one provided coating composition Cᵢ results in a coating layer CLᵢ having a high scratch resistance and at least one further provided coating composition Cₙ₋ᵢ results in a coating layer CLₙ₋ᵢ having a lower scratch resistance and/or wherein at least one provided coating composition Cᵢ results in a coating layer CLᵢ having a high light resistance and at least one further provided coating composition Cₙ₋ᵢ results in a coating layer CLₙ₋ᵢ having a lower light resistance.

4. The process according to claim 1, wherein each provided coating composition (C₁, . . . , Cₙ) comprises at least one binder, said at least one binder being identical to at least one binder being present in the other provided coating compositions or wherein each provided coating composition comprises at least one binder being different from the binder(s) present in the other provided coating compositions.

5. The process according to claim 1, wherein each provided coating composition (C₁, . . . , Cₙ) only differs in the amount and/or type of ingredient(s) necessary to achieve properties of the respective resulting coating layer (C₁, . . . , Cₙ) which are matching a set of properties identified in step (a).

6. The process according to claim 1, wherein step (b) includes
(b-1) providing at least two components (Aᵢ)_{i=1, . . . , n} having different properties and optionally at least one hardener component B,
(b-2) selecting mixing ratio(s) for at least part of the components Aᵢ provided in step (b-1) to result in a coating layer CLᵢ having properties matching a set of properties identified in step (a),
(b-3) optionally selecting mixing ratio(s) for the at least one hardener component B provided in step (b-1), and
(b-4) mixing components Aᵢ, optionally with the at least one hardener component B in the mixing ratio(s) selected in step (b-2) and optionally (b-3) to provide the coating composition Cᵢ resulting in a coating layer CLᵢ having properties matching a set of properties identified in step (a).

7. The process according to claim 6, wherein step (b-2) includes determining the required properties of the coating layer CLᵢ and selecting a mixing ratio for at least part of the components provided in step (b-1) such that properties of the resulting coating layer CLᵢ which match a set of properties identified in step (a) are achieved.

8. The process according to claim 1, wherein step (b) includes preparing the at least two different compositions (Cᵢ)_{i=1, . . . , n} by mixing at least two coating material ingredients such that the coating layers (Cᵢ)_{i=1, . . . , n} resulting from the respective coating compositions each have properties matching a different set of properties identified in step (a).

9. The process according to claim 8, wherein the coating material ingredients include
a base component BCᵢ, and
at least one hardener component B.

10. process according to claim 6, wherein components Aᵢ are mixed, optionally with the hardener component(s) B, in the selected mixing ratios prior to supplying the resulting coating composition Cᵢ to an application equipment and/or wherein the at least one base component BCᵢ is mixed with the at least one hardener component B prior to supplying the resulting coating composition Cᵢ to an application equipment.

11. The process according to claim 6, wherein each coating composition Cᵢ is obtained by mixing components Aᵢ, optionally with the hardener component(s) B, in the selected mixing ratios within an application equipment and/or wherein the at least one base component BCᵢ is mixed with the at least one hardener component B within an application equipment.

12. The process according to claim 1, wherein each provided coating composition (C₁, . . . , Cₙ) is applied onto all target areas having the same set of properties.

13. The process according to claim 1, further including a step (s) of curing, or drying and curing the applied coating composition(s).

14. A method of using the process according to claim 1, the method comprising using the process for coating target areas of a substate having different orientations relative to each other.

15. A system for applying—utilizing an application device—at least two coating compositions resulting in coating layers having adjustable properties to an object comprising a plurality of target areas, at least part of the plurality of target areas having a different set of properties, the system comprising:
an application device comprising a nozzle;
a storage device for storing application instructions and optionally mixing ratio instructions;
one or more data processors configured to execute the application instructions and optionally the mixing ratio instructions to control the application device; and
at least two reservoirs in fluid communication with the application device and configured to contain at least two components (Aᵢ)_{i=1, . . . , n} and optionally at least one hardener component B, each component Aᵢ or each mixture of Aᵢ and B resulting in a coating layer CLᵢ having properties matching a set of properties of target area(s), or configured to contain at least two coating compositions (Cᵢ)_{i=1, . . . , n} resulting in coating layer (CLᵢ)_{i=1, . . . , n} each coating layer CLᵢ having properties matching a set of properties of target area(s),
wherein the application device is configured to
receive the components (Aᵢ)_{i=1, . . . , n} and optionally the hardener component B from the reservoir and to mix the components (Aᵢ)_{i=1, . . . , n}, optionally with the hardener component B based on the mixing ratio instructions within the nozzle, and
to expel the resulting coating compositions (Cᵢ)_{i=1, . . . , n} based on the application instruction through the nozzle to target area(s) having a matching set of properties to form at least two coating layers; or
wherein the applicator is configured to
receive the at least two coating compositions (Cᵢ)_{i=1, . . . , n} from the reservoir, and
to expel the coating compositions (Cᵢ)_{i=1, . . . , n} based on the application instruction through the nozzle to target area(s) having a matching set of properties to form at least two coating layers.
